(19) United States
(12) Patent Application Publication
(10) Pub. No.: US 2025/0124657 A1
(43) Pub. Date: Apr. 17, 2025

(54) TRIANGLE GENERATION APPARATUS, TRIANGLE GENERATION METHOD, AND TRIANGLE GENERATION PROGRAM

(71) Applicant: DENSO CORPORATION, Kariya-city (JP)

(72) Inventor: Tomihiro IKEGAMI, Kariya-city (JP)

(21) Appl. No.: 18/990,433

(22) Filed: Dec. 20, 2024

Related U.S. Application Data
(63) Continuation of application No. PCT/JP2023/023360, filed on Jun. 23, 2023.

(30) Foreign Application Priority Data
Jun. 24, 2022 (JP) 2022-102151

(51) Int. Cl. G06T 17/20; G06T 11/20

(52) U.S. Cl. CPC G06T 17/205; G06T 11/203; G06T 2210/36

(57) ABSTRACT

A triangle generation apparatus includes an acquisition unit and a triangle division unit. The acquisition unit acquires a vertex coordinate group including coordinates of each vertex of one or a plurality of basic triangles. The triangle division unit divides each basic triangle defined by the coordinates of the vertices included in the vertex coordinate group into a plurality of subdivided triangles. The triangle division unit determines whether each basic triangle defined by the vertex coordinate group is a target triangle that has a shape having a relatively high degree of similarity to an equilateral triangle. The triangle division unit divides the basic triangle determined to not be the target triangle into a plurality of triangles to have the shape having a relatively high degree of similarity to an equilateral triangle. The triangle division unit generates the new vertex coordinate group including the vertex coordinates of the triangles after division.

### CROSS-REFERENCE TO RELATED APPLICATION

The present application is a continuation application of International Application No. PCT/JP2023/023360, filed on Jun. 23, 2023, which claims priority to Japanese Patent Application No. 2022-102151, filed on Jun. 24, 2022. The contents of these applications are incorporated herein by reference in their entirety.

### BACKGROUND

### Technical Field

The present disclosure relates to a technology for generating a plurality of new triangles by dividing a triangle.

### Related Art

For example, a technology related to tessellation is known in which a triangle is bisected to become a predetermined size or smaller.

Tessellation is an image calculation method in computer graphics. Tessellation is a technique in which, for example, multiple polygons (such as triangular polygons) used to express a three-dimensional object in a two-dimensional image are further divided into smaller parts. The technique is used to express the three-dimensional object more smoothly and in greater detail based on the triangles after division.

### SUMMARY

One aspect of the present disclosure provides a triangle generation apparatus that includes an acquisition unit and a triangle division unit. The acquisition unit acquires a vertex coordinate group including coordinates of each vertex of one or a plurality of basic triangles. The triangle division unit divides each basic triangle defined by the coordinates of the vertices included in the vertex coordinate group into a plurality of subdivided triangles. The triangle division unit determines whether each basic triangle defined by the vertex coordinate group is a target triangle that has a shape having a relatively high degree of similarity to an equilateral triangle. The triangle division unit divides the basic triangle determined to not be the target triangle into a plurality of triangles to have the shape having a relatively high degree of similarity to an equilateral triangle. The triangle division unit generates the new vertex coordinate group including the vertex coordinates of the triangles after division. For each basic triangle defined by the coordinates of the vertices of the new vertex coordinate group, the triangle division unit calculates the coordinates of the vertices of a plurality of subdivided triangles dividing an area of the basic triangle into parts smaller than the basic triangle.

### BRIEF DESCRIPTION OF THE DRAWINGS

In the accompanying drawings:

FIG. 1 is a block diagram illustrating a configuration of a radar simulator;

FIG. 2 is a flowchart illustrating a triangle generation process;

FIG. 3 is a flowchart illustrating triangle division;

FIG. 4 is a flowchart illustrating pre-shaping;

FIG. 5 is an explanatory diagram for explaining rearrangement so that lengths of opposing sides are in descending order;

FIG. 6 is an explanatory diagram illustrating elements vertices[] of an array before rearrangement;

FIG. 7 is an explanatory diagram illustrating elements vertices[] of the array after rearrangement;

FIG. 8 is an explanatory diagram for explaining division of a non-target triangle;

FIG. 9 is an explanatory diagram illustrating a plurality of basic triangles for explaining workings of pre-shaping;

FIG. 10 is an explanatory diagram illustrating each array for explaining the workings of pre-shaping;

FIG. 11 is a flowchart illustrating multi-stage division;

FIG. 12 is an explanatory diagram for explaining each side and each vertex of the basic triangle;

FIG. 13 is an explanatory diagram for explaining an overview of a minor line process;

FIG. 14 is an explanatory diagram for explaining an overview of a subdivision process;

FIG. 15 is a flowchart illustrating a major line process;

FIG. 16 is a flowchart illustrating the minor line process;

FIG. 17 is a flowchart illustrating a prim_lookup_idx array generation process;

FIG. 18 is a flowchart illustrating the subdivision process;

FIG. 19 is a flowchart illustrating a maj_line_lookup_idx array generation process;

FIG. 20 is an explanatory diagram for explaining workings of the major line process;

FIG. 21 is an explanatory diagram for explaining workings of the minor line process;

FIG. 22 is an explanatory diagram for explaining the subdivision process;

FIG. 23 is an explanatory diagram for explaining combination information;

FIG. 24 is an explanatory diagram illustrating an example of an array prim_lookup_idx[];

FIG. 25 is an explanatory diagram illustrating an example of an array maj_line_lookup_idx[];

FIG. 26 is an explanatory diagram illustrating subdivided triangles that divide an area sandwiched between a minor line pair set for a first major line point specified by maj_div_idx=3 in a basic triangle specified by prim_id−0 in FIG. 20 to FIG. 23;

FIG. 27 is an explanatory diagram illustrating an example of a displacement amount of a primary division point identification number;

FIG. 28 is an explanatory diagram illustrating an example of a displacement amount of a secondary division point identification number;

FIG. 29 is an explanatory diagram for explaining each parameter in each basic triangle specified by prim_id=0 to 2 in FIG. 20 to FIG. 23;

FIG. 30 is a flowchart illustrating cumulative sum parallel processing; and

FIG. 31 is an explanatory diagram for explaining workings of cumulative sum parallel processing.

### DESCRIPTION OF THE EMBODIMENTS

In a method described in U.S. Pat. No. 10,832,473 B2, a division line being drawn from a certain vertex of a triangle toward an opposing side thereof and the triangle being bisected by the division line is repeatedly performed. For example, in this method, in cases in which the triangle before division is a relatively elongated triangle, the triangle after division may also become a relatively elongated triangle. That is, the triangle after division may become less like an equilateral triangle.

However, in image calculation in computer graphics, it is known that, as a triangle becomes less like an equilateral triangle (that is, as an aspect ratio of a triangle decreases), analysis accuracy decreases, calculation time increases, and the like.

It is thus desired to preferably suppress a new triangle generated by a triangle being divided from becoming less like an equilateral triangle.

An exemplary embodiment of the present disclosure is a triangle generation apparatus that includes an acquisition unit and a triangle division unit. The acquisition unit is configured to acquire a vertex coordinate group including coordinates of each vertex of one or a plurality of basic triangles. The triangle division unit is configured to divide each basic triangle defined by the coordinates of the vertices included in the vertex coordinate group into a plurality of subdivided triangles. In addition, the triangle division unit has a target determining unit, a pre-shaping execution unit, and an addition unit.

The target determining unit is configured to determine whether each basic triangle defined by the vertex coordinate group is a target triangle that has a shape having a relatively high degree of similarity to an equilateral triangle. The pre-shaping execution unit is configured to divide the basic triangle determined to not be the target triangle into a plurality of triangles to have the shape having a relatively high degree of similarity to an equilateral triangle. The addition unit is configured to generate the new vertex coordinate group including the vertex coordinates of the triangles after division.

For each basic triangle defined by the coordinates of the vertices included in the new vertex coordinate group generated by the addition unit, the triangle division unit calculates the coordinates of the vertices of a plurality of subdivided triangles dividing an area of the basic triangle into parts smaller than the basic triangle.

In the triangle generation apparatus according to an exemplary embodiment of the present disclosure configured in this manner, the basic triangle defined by the coordinates of the vertices included in the new vertex coordinate group generated by the addition unit has the shape having a relatively high degree of similarity to an equilateral triangle through execution by the pre-shaping execution unit. The triangle generation apparatus according to an aspect of the present disclosure calculates the coordinates of the vertices of the plurality of subdivided triangles for each basic triangle that has the shape having a relatively high degree of similarity to an equilateral triangle such as this. Therefore, compared to a case in which the basic triangle is divided into subdivided triangles without execution by the pre-shaping execution unit, the triangle generation apparatus according to an aspect of the present disclosure can obtain a subdivided triangle having a relatively high degree of similarity to an equilateral triangle. As a result, the new subdivided triangle generated by the basic triangle being divided can be suppressed from becoming unlike an equilateral triangle.

Another exemplary embodiment of the present disclosure is a triangle generation method that is configured to acquire a vertex coordinate group including coordinates of each vertex of one or a plurality of basic triangles and divide each basic triangle defined by the coordinates of the vertices included in the vertex coordinate group into a plurality of subdivided triangles.

The triangle generation method according to another exemplary embodiment of the present disclosure configured in this manner is a method performed by a triangle generation apparatus according to an aspect of the present disclosure and can achieve effects similar to those of the triangle generation apparatus according to an aspect of the present disclosure.

Still another exemplary embodiment of the preset disclosure is a triangle generation program executed by a triangle generation apparatus according to an aspect of the present disclosure and includes an acquiring step and a triangle dividing step. The triangle generation program according to another aspect of the present disclosure is a program that is executed by the triangle generation apparatus according to an aspect of the present disclosure and can achieve effects similar to those of the triangle generation apparatus according to an aspect of the present disclosure as a result of the program being executed.

### First embodiment

A first embodiment of the present disclosure will hereinafter be described with reference to the drawings.

### [1-1. Configuration]

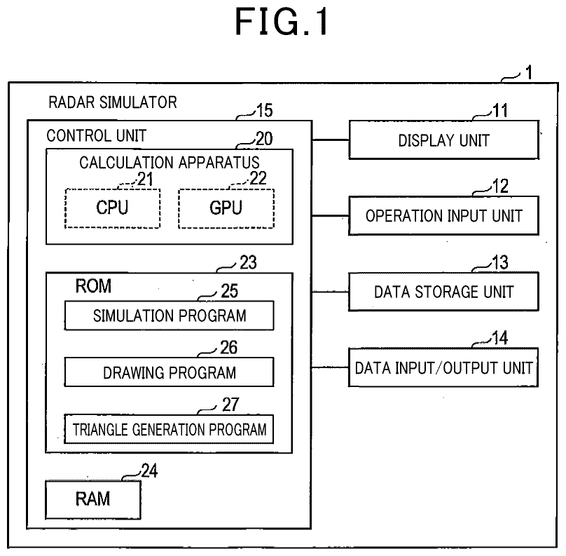

As shown in FIG. 1, a radar simulator 1 according to the present embodiment includes a display unit 11, an operation input unit 12, a data storage unit 13, a data input/output unit 14, and a control unit 15.

The display unit 11 includes a display apparatus (not shown) and displays various types of images on a display screen of the display apparatus.

The operation input unit 12 outputs input operation information for identifying an input operation performed by a user through a keyboard and a mouse (not shown).

The data storage unit 13 is a storage apparatus for storing therein various types of data.

The data input/output unit 14 performs input and output of data to and from an external apparatus that is connected wirelessly or by wired connection.

The control unit 15 is mainly configured by a microcomputer that includes an electronic calculation apparatus (referred to, hereafter, as a calculation apparatus 20), a read-only memory (ROM) 23, a random access memory (RAM) 24, and the like. The calculation apparatus 20 includes at least either of a central processing unit (CPU) 21 and a graphics processing unit (GPU) 22. Various functions of the microcomputer are actualized by the calculation apparatus 20 executing a program stored in a non-transitory, tangible storage medium. In this example, the ROM 23 corresponds to the non-transitory, tangible storage medium in which the program is stored. In addition, as a result of the program being executed, a method corresponding to the program is performed. Here, some or all functions provided by the calculation apparatus 20 may be configured by hardware using one or a plurality of integrated circuits (ICs) or the like. In addition, the control unit 15 may be configured by a single or a plurality of microcomputers.

For example, the ROM 23 may store a simulation program 25, a drawing program 26, and a triangle generation program 27. The simulation program 25, the drawing program 26, and the triangle generation program 27 may be installed in the radar simulator 1 in advance or may be installed through a storage medium or over a network. For example, an optical disc, a magnetic disk, and a semiconductor memory can be given as the storage medium.

The simulation program 25 is a program for executing a simulation in which a three-dimensional shape of a road, three-dimensional shapes surrounding the road, and the like are reproduced in a virtual space, and a vehicle is made to travel on the road reproduced in the virtual space. For example, the simulation may include a simulation in which, in the vehicle that travels in the virtual space displayed in the display apparatus, transmission and reception of radar waves by a radar apparatus mounted in the vehicle is simulated. Radar simulation in which the traveling of the vehicle, and the transmission and reception of radar waves by the radar apparatus are simulated may be performed by the simulation program 25 being started.

Data (hereafter, polygon data) in which the above-described three-dimensional shapes of the road and the road surroundings, and the like to be reproduced in the virtual space are expressed by numerous polygons may be acquired by the simulation program 25 being started. In addition, calculation simulating transmission and reception of radar waves may be performed based on the polygon data indicating the three-dimensional shapes. Here, simulation may include various other types of simulations.

For example, the drawing program 26 may be a program for generating an image that shows the three-dimensional shapes of the road and the road surroundings, and the like reproduced in the virtual space used in the above-described radar simulation. The drawing program 26 may be started with the start of the simulation program 25 as a trigger. Alternatively, the drawing program 26 may be started by itself. The above-described polygon data of the three-dimensional shapes of the roads and the road surroundings, and the like to be reproduced in the virtual space may be acquired, and an image indicating the three-dimensional shapes may be generated by the drawing program 26 being started.

Numerous pieces of polygon data expressing the three-dimensional shapes and the like may be stored in the data storage unit 13 in advance or may be acquired from outside the radar simulator 1 through the data input/output unit 14. The polygon data includes polygon vertex coordinate data that indicates coordinates of each vertex (hereafter, vertex coordinates) of numerous polygons (such as triangular polygons).

For example, the triangle generation program 27 may be a program for dividing each triangular polygon (also referred to, hereafter, a basic triangle) defined by the vertex coordinates included in the polygon vertex coordinate data into a plurality of triangles smaller than the basic triangle. A process performed by the calculation apparatus 20 executing the triangle generation program 27 is also referred to as a triangle generation process.

Through the triangle generation process, new vertex coordinate data including the vertex coordinates of the triangles that are smaller than the basic triangle is outputted, and an image showing the three-dimensional shapes is generated based on the outputted vertex coordinate data. As a result, a smoother, more detailed image is generated in drawings and the like in the display apparatus by the display unit 11.

### [1-2. Processes]

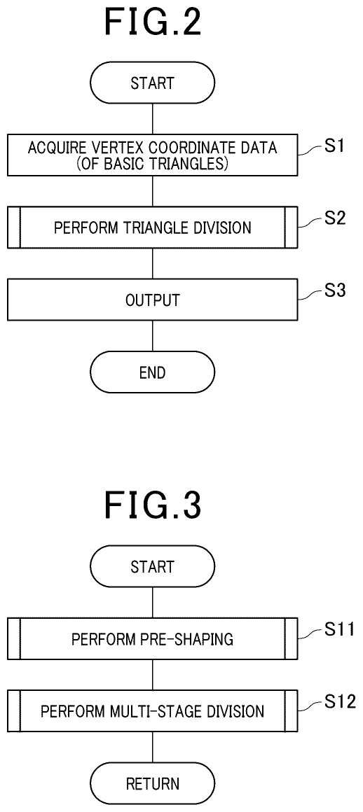

Steps in the triangle generation process performed by the calculation apparatus 20 will be described with reference to a flowchart in FIG. 2. For example, the triangle generation process may be started with the simulation program 25 being executed or the drawing program 26 being executed as the trigger. However, the trigger for performing the triangle generation process is not limited to the simulation program 25 or the drawing program 26 being executed. The triangle generation process may be performed based on an arbitrary trigger.

When the triangle generation process is performed, at S1, the calculation apparatus 20 acquires the polygon vertex coordinate data. For example, the polygon vertex coordinate data may include the vertex coordinates of a plurality of basic triangles.

Next, at S2, the calculation apparatus 20 performs triangle division. In triangle division, the basic triangle is divided and a plurality of triangles (also referred to, hereafter, as subdivided triangles) smaller than the basic triangle is generated. Here, generating a triangle as described hereafter includes performing calculation to calculate the vertex coordinates of the triangle and outputting (that is, storing) the calculated vertex coordinates to a memory such as the RAM 24.

At S3, the calculation apparatus 20 outputs new vertex coordinate data including the vertex coordinates of the triangles (that is, the subdivided triangles) smaller than the basic triangle. For example, the calculation apparatus 20 may output the above-described vertex coordinate data to an arbitrary memory or the like that can be used in the simulation program 25, the drawing program 26, and other applications. The calculation apparatus 20 then ends the triangle generation process.

Next, details of the triangle division (that is, the triangle generation process) performed by the calculation apparatus 20 at S2 will be described with reference to a flowchart shown in FIG. 3.

At S11, the calculation apparatus 20 performs pre-shaping (that is, pre-tessellation reshaping). Pre-shaping refers to a process for shaping a triangle that, among the basic triangles, has a shape having a relatively low degree of similarity to an equilateral triangle to become a plurality of triangles that have shapes having a relatively high degree of similarity to an equilateral triangle, based on the polygon vertex coordinate data.

At subsequent S12, the calculation apparatus 20 performs multi-stage division (that is, cascade tessellation). Multi-stage division refers to a process for generating the subdivided triangles for each of the basic triangles. According to the present embodiment, the above-described pre-shaping process is performed as pre-processing before multi-stage division (that is, before the subdivided triangles are generated). That is, according to the present embodiment, multi-stage division is performed on a basic triangle having a shape relatively similar to the equilateral triangle. In addition, according to the present embodiment, the subdivided triangles are a plurality of triangles smaller than the basic triangle that are obtained by the basic triangle having a shape relatively similar to the equilateral triangle being divided. The calculation apparatus 20 then ends triangle division.

### [1-2-1. Pre-shaping]

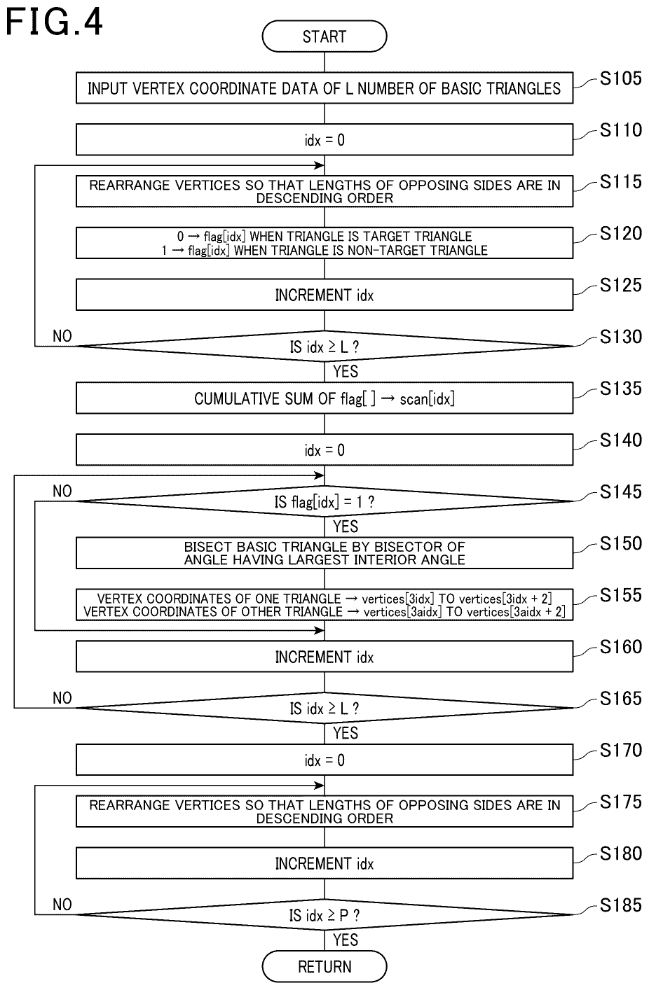

Details of pre-shaping performed by the calculation apparatus 20 at S11 will be described with reference to a flowchart shown in FIG. 4.

### <Processes>

First, at S105, the calculation apparatus 20 acquires the polygon vertex coordinate data. There are three vertex coordinates for each basic triangle. Here, the polygon vertex coordinate data includes the vertex coordinates of an L number of basic triangles. For example, elements included in the polygon vertex coordinate data may be indicated such as by (v₀, v₁, v₂, v₃, v₄, v₅, . . . , v₃ₖ, v₃ₖ₊₁, v₃ₖ₊₂, . . . ). k is an integer from 0 to L−1. v is the vertex coordinates. For example, the vertex coordinates v may be expressed by coordinates such as (x, y) or may be expressed by a position vector.

Hereafter, the polygon vertex coordinate data is written as an array vertices[]. An element vertices[] of the array is expressed by a floating-point number. Here, regarding the element of the array, the element of the array vertices[] may be written such that [] is omitted, for example, by being simply written as vertices. An index (hereafter, idx) is a variable for specifying an element in the array. Here, the index is within a range of 0≤idx≤L−1. That is, elements vertices[3idx], vertices[3idx+1], and vertices[3idx+2] of the array indicate the vertex coordinates of a single basic triangle specified by idx. 3idx or 3*idx expresses a multiplication of 3 and idx. For example, a basic triangle specified by idx=0may be a basic triangle in which the vertex coordinates stored in elements vertices[0], vertices[1], and vertices[2] of the array (that is, specifically, (v₀, v₁, v₂) described above) are the vertices of the triangle.

At S110 to S130, the calculation apparatus 20 identifies a triangle that is not a target triangle among the basic triangles specified by the values stored in idx. The target triangle is a triangle that has a shape relatively similar to an equilateral triangle. A shape relatively similar to an equilateral triangle is a shape that has a relatively high degree of similarity to an equilateral triangle. The degree of similarity to an equilateral triangle may be, for example, expressed by an aspect ratio. The aspect ratio has a range of 0≤aspect ratio≤1 and the aspect ratio of the equilateral triangle is 1. The degree of similarity to an equilateral triangle increases as the aspect ratio becomes relatively large (that is, relatively closer to 1). The target triangle can also be said to be a triangle that has a relatively large aspect ratio (that is, relatively close to 1). A triangle that is not the target triangle is also referred to hereafter as a non-target triangle.

First, at S110, the calculation apparatus 20 stores 0 in idx.

Next, at S115, the calculation apparatus 20 changes a storage order of the vertex coordinates in the array vertices[] so that lengths of opposing sides are in descending order for the basic triangle specified by the value stored in idx. That is, the vertex coordinates stored in the elements vertices[3idx], vertices[3idx+1], and vertices[3idx+2] of the array are rearranged so that the lengths of the opposing sides are in descending order. The opposing side refers to a side facing the vertex. Descending order refers to arranging in order from long to short.

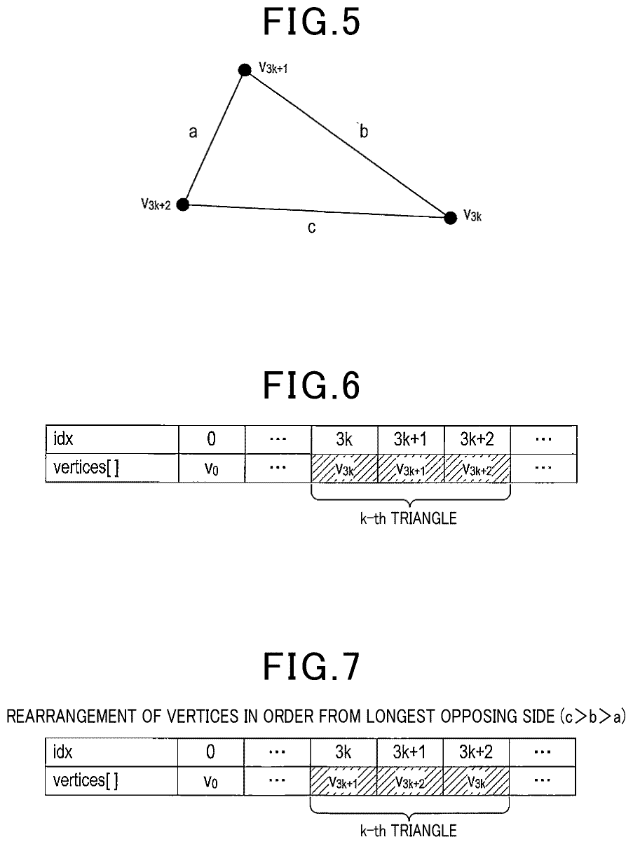

For example, FIG. 5 shows a certain basic triangle specified by idx=k. The elements of the array before rearrangement are shown in FIG. 6. That is, the vertex coordinates stored in the element vertices[3k] of the array are V₃ₖ, the vertex coordinates stored in the element vertices[3k+1] of the array are V_{3k+1,}and the vertex coordinates stored in the element vertices[3k+2] of the array are V₃ₖ₊₂.

First, the calculation apparatus 20 calculates the length of an opposing side a of the vertex indicated by the vertex coordinates v₃ₖ, the length of an opposing side b of the vertex indicated by the vertex coordinates v₃ₖ₊₁, and the length of an opposing side c of the vertex indicated by the vertex coordinates v₃ₖ₊₂ based on the vertex coordinates. Then, the calculation apparatus 20 identifies the order from the longest length (that is, the descending order of the length) for the opposing side a, the opposing side b, and the opposing side c. In the example in FIG. 5, the lengths of the opposing sides are c>b>a. The calculation apparatus 20 rearranges the order of the vertices so that the vertices corresponding to the identified order of the lengths of the opposing sides (that is, c>b>a) are arranged in order.

As a result, after rearrangement, as shown in FIG. 7, v₃ₖ₊₁ is stored as the element vertices[3k] of the array, v₃ₖ₊₂ is stored as the element vertices[3k+1] of the array, and v₃ₖ is stored as the element vertices[3k+2] of the array. That is, the vertex coordinates are rearranged so that the lengths of the opposing sides are in descending order.

Next, at S120, the calculation apparatus 20 determines whether the basic triangle specified by the value stored in idx is the above-described target triangle. Here, according to the present embodiment, the calculation apparatus 20 determines that the basic triangle is the target triangle when a maximum value of an interior angle is less than an allowable angle prescribed in advance. Meanwhile, the calculation apparatus 20 determines that the basic triangle is the non-target triangle when the maximum value of the interior angle is equal to or greater than the allowable angle. According to the present embodiment, the allowable angle is 120°. Here, the allowable angle is not limited to 120° and may be an arbitrary angle within a predetermined range including 120°.

As described above, the vertex coordinates of the basic triangle specified by the value stored in idx are rearranged so that the lengths of the opposing sides are in descending order in the array vertice[]. That is, among the elements vertices[3idx], vertices[3idx+1], and vertices[3idx +2] of the array, the vertex coordinates stored as a leading element vertices[3idx] of the array indicates the vertex having the largest interior angle.

The calculation apparatus 20 calculates θ as the angle indicating the maximum value of the interior angle using c²=a²+b²−2abcosθ that is a cosine theorem. Here, c is the length of the opposing side of the vertex having the largest interior angle, and a and b are the lengths of the remaining sides. The opposing side of the vertex having the largest interior angle is the opposing side of the vertex indicated by the vertex coordinates stored in the element vertices[3idx] of the array that is the leading vertex coordinates of the three vertex coordinates. The remaining sides are the opposing sides of the vertex coordinates stored in the elements vertices[3idx+1] and vertices[3idx+2] of the array.

An array flag[idx] indicates a value of a flag related to the basic triangle specified by the value stored in idx. Here, the calculation apparatus 20 stores 1 in the array flag[idx] when the basic triangle is deterred to be a non-target triangle, that is, the maximum value θ of the interior angle is equal to or greater than the allowable angle. Meanwhile, the calculation apparatus 20 stores 0 in the array flag[idx] when the basic triangle is determined to be a target triangle, that is, the maximum value θ of the interior angle is less than the allowable angle.

At S125, the calculation apparatus 20 increments idx. That is, the calculation apparatus 20 stores, in idx, a value obtained by adding 1 to the value stored in idx.

At S130, the calculation apparatus 20 determines whether the value stored in idx is equal to or greater than L. Here, the calculation apparatus 20 transitions the process to S135 when determined that the value is equal to or greater than L. Meanwhile, the calculation apparatus 20 transitions the process to S115 when determined that the value is less than L, and repeats the processes at S115 to S130 until idx becomes equal to or greater than L.

At S135, the calculation apparatus 20 stores a cumulative sum of elements flag[] of the array in an array scan[idx] specified by the value stored in idx. The cumulative sum of the elements flag[] of the array herein is a total sum of respective values of the elements flag[0] to flag[idx] of the array.

For example, the value stored as the element flag[0] of the array may be stored as an element scan[0] of the array. A total sum (that is, the cumulative sum) of the value stored as the element flag[0] of the array and the value stored as the element flag[1] of the array is stored as the element scan[1] of the array. As a result, a total number of non-target triangles among the L number of basic triangles is stored as the element scan[L−1] of the array when the value stored in idx is L−1.

At S140 to S165, the calculation apparatus 20 divides the basic triangle determined to be the non-target triangle at S120 into a plurality (such as two, according to the present embodiment) of triangles so as to have shapes having a relatively high degree of similarity to an equilateral triangle.

First, at S140, the calculation apparatus 20 stores 0 in idx.

At S145, the calculation apparatus 20 determines whether the basic triangle specified by the value stored in idx is the target triangle or the non-target triangle. Here, when the value stored as the element flag[idx] of the array is 1, the calculation apparatus 20 determines that the basic triangle is the non-target triangle and transitions the process to S150. Meanwhile, when the value stored as the element flag[idx] of the array is 0, the calculation apparatus 20 determines that the basic triangle is the target triangle and transitions the process to S160.

At S150, the calculation apparatus 20 divides the basic triangle specified by the value stored in idx by a bisector of the interior angle indicating the maximum value so that the triangles after division have shapes having a relatively high degree of similarity to an equilateral triangle.

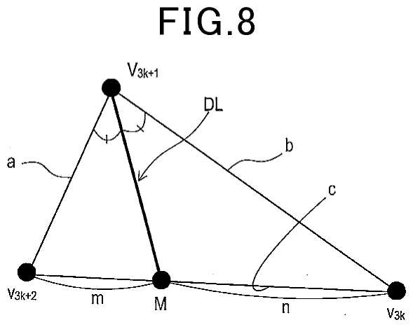

As described above, in the basic triangle specified by the value stored in idx, the vertex indicated by the vertex coordinates stored in the element vertices[3idx] of the array indicates the vertex having the largest interior angle. For example, as shown in FIG. 8, when a division line DL drawn from the vertex having the largest interior angle (such as the vertex coordinates v₃ₖ₊₁) toward the opposing side (such as the side c) is the bisector of the interior angle, an intersection between the division line DL and the side c may be a point M. The side c is divided into m:n=a:b by the point M. The calculation apparatus 20 calculates the coordinates of the point M based on expression (1).

$$\begin{matrix}M = {v}_{3 k + 2} + \frac{m}{m + n} ( {v}_{3 k} - {v}_{3 k + 2} ) \\ = \frac{n}{m + n} {v}_{3 k + 2} + \frac{m}{m + n} {v}_{3 k} \\ = \frac{a}{a + b} {v}_{3 k + 2} + \frac{b}{a + b} {v}_{3 k}\end{matrix} \qquad ( 1 )$$

Here, of the divided triangles, the calculation apparatus 20 respectively stores the vertex coordinates (that is, v₃ₖ₊₁ in FIG. 8) stored in the element vertices[3idx] of the array, the vertex coordinates (that is, v₃ₖ₊₂) stored in the element vertices[3idx+1] of the array, and the coordinates of the point M as the elements vertices[3idx], vertices[3idx+1], and vertices[3idx+2] of the array.

Meanwhile, of the divided triangles, the calculation apparatus 20 adds, to the end of the array vertices[], the vertex coordinates (that is, v₃ₖ₊₁ in FIG. 8) stored in the element vertices[idx] of the array, the vertex coordinates (that is, v₃ₖ) stored in the element vertices[idx+2] of the array, and the coordinates of the point M as the vertex coordinates of a new basic triangle.

Specifically, for example, the calculation apparatus 20 may store, in a variable aidx, a value obtained by adding the value stored in the element scan[idx] of the array to L−1 that is the value stored in idx specifying the end of the array vertices[]. aidx=(L−1)+scan[idx]. Then, as the vertices of the basic triangle in which aidx is specified as idx, the vertex coordinates (that is, v₃ₖ₊₁) stored in the element vertices[3idx] of the array, the vertex coordinates (that is, v₃ₖ) stored in the element vertices[3idx+2] of the array, and the coordinates of the point M are respectively stored as the elements vertices[3aidx], vertices[3aidx+1], and vertices[3aidx+2] of the array. As a result, the vertex coordinates of the new basic triangle are added to the end of the array vertices[].

Here, the calculation apparatus 20 may reverse the array in which the vertex coordinates of the triangles after division are stored from that described above. That is, in the above-described example, the vertex coordinates v₃ₖ₊₁, the vertex coordinates v₃ₖ, and the coordinates of the point M may respectively be stored as the elements vertices[3idx], vertices[3idx+1], and vertices[3idx+2] of the array. In addition, the vertex coordinates v₃ₖ₊₁, the vertex coordinates v₃ₖ₊₂, and the coordinates of the point M may respectively be stored as the elements vertices[3aidx], vertices[3aidx+1], and vertices[3aidx+2] of the array.

At S160, the calculation apparatus 20 increments idx. That is, the calculation apparatus 20 stores, in idx, a value obtained by adding 1 to the value stored in idx.

At S165, the calculation apparatus 20 determines whether the value stored in idx is equal to or greater than L. Here, the calculation apparatus 20 transitions the process to S170 when determined that the value is equal to or greater than L. Meanwhile, the calculation apparatus 20 transitions the process to S145 when determined that the value is less than L, and repeats the processes from S145 to S165 until idx becomes equal to or greater than L.

At S170 to S185, regarding the basic triangle specified by the value stored in idx, the calculation apparatus 20 again rearranges the vertex coordinates stored in the elements vertices[3idx], vertices[3idx+1], and vertices[3idx+2] of the array so that the lengths of the opposing sides are in descending order. Here, at S170 to S185, idx is within a range of 0<idx≤P. P is a value stored as an element scan[L−1] of an (L−1)+array. The processes at S170, S175, and S180 are respectively similar to those at S110, S115, and S125.

At S185, the calculation apparatus 20 ends the pre-shaping process when determined that idx is equal to or greater than P.

As a result, the vertex coordinates of the basic triangle of which the maximum value of the interior angle is equal to or less than 120° are stored in order in the array vertices[].

### <Workings>

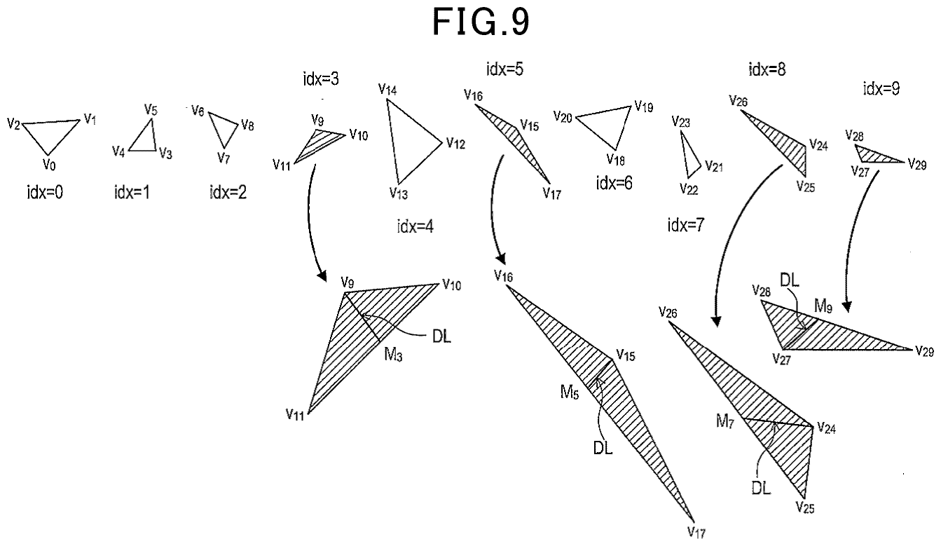

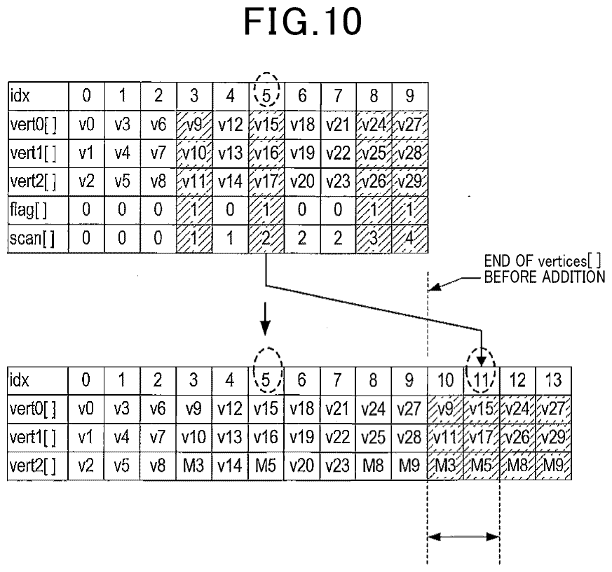

Workings of the pre-shaping process will be described with reference to FIG. 9 and FIG. 10. FIG. 9 shows an example in which the vertex coordinates of ten basic triangles are included in the vertices[] (that is, L=10). FIG. 10 shows the array vertices[], the array flag[], and the array scan[]. Here, in FIG. 10, in the array vertices[], the value stored in the array vertices[3idx] is written as vert[0], the value stored in the array vertices[3idx+1] is written as vert[1], and the value stored in the array vertices[3idx +2] is written as vert[2].

At S115, the calculation apparatus 20 rearranges the vertices inside the basic triangle so that the lengths of the opposing sides are in descending order. As a result, for example, as shown in FIG. 10, the vertex coordinates may be stored in the array vertices[] (that is, vert[0] to vert[2]) as v₀, v₁, v₂, . . .

At S120, the calculation apparatus 20 identifies the non-target triangle. As a result, for example, as shown in FIG. 10, the basic triangles specified by idx=3, 5, 8, and 9 may be identified as non-target triangles, and 1 may be stored as the elements flag[3], [5]. [8], and [9] of the array.

At S135, the calculation apparatus 20 identifies the cumulative sum of the flag[]. As a result, for example, as shown in FIG. 10, 1 may be stored as the element of the array scan[3] specified by idx=3, and 4 that is a cumulative value is stored as the element of the array scan[0] specified by idx=9.

At S150, the calculation apparatus 20 divides the basic triangles specified by idx=3, 5, 8, and 9 identified as non-target triangles, and updates the array vertices[] with the triangles after division as the new basic triangles. For example, the basic triangle specified by idx=5 may be divided into a triangle of which the vertex coordinates are v15, v16, and point M5, and a triangle of which the vertex coordinates are v15, v17, and point M5 by the division line DL. In variable aidx, 11 that is a value obtained by 2 that is a value stored in the element scan[5] of the array being added to 9 (that is, a value indicating L−1) is stored.

Here, v15, v16, and point M5 are stored as the elements vertices[3*5], [3*5+1], and [3*5+2] of the array. That is, v15, v16, and point M5 are stored as the element vert0[5] of the array, the element vert1[5] of the array, and the element vert2[5] of the array in the basic triangle specified by idx=5. Meanwhile, v15, v17, and point M5 are stored as the elements vertices[3*11], [3*11+1], and [3*11+2] of the array. That is, v15, v17, and point M5 are stored as the element vert0[11] of the array, the element vert1[11] of the array, and the element vert2[11] of the array in the basic triangle specified by a new idx (that is, aidx)=11.

At S175, the calculation apparatus 20 again rearranges the vertices in the basic triangle so that the lengths of the opposing sides are in descending order. As a result, although not shown, in a new array vertices[], the vertex coordinates are stored such that the lengths of the opposing sides are in descending order in the basic triangle specified by the value stored in idx.

### [1-2-2. Overview of Multi-Stage Division]

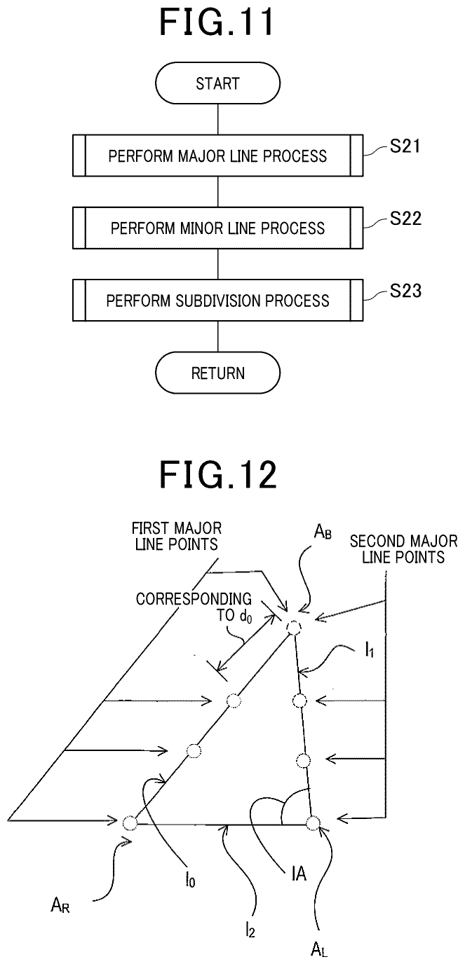

An overview of multi-stage division performed by the calculation apparatus 20 at S12 will be described with reference to a flowchart in FIG. 11, and FIG. 12 to FIG. 14. A triangle shown in FIG. 12 to FIG. 14 is a certain basic triangle defined by the vertex coordinates included in the above-described array vertices[]. According to the present embodiment, because pre-shaping is performed as described above, each of the basic triangles defined by the vertex coordinates included in the array vertices[] has a shape having a relatively high degree of similarity to an equilateral triangle.

### <Names>

First, names of line segments and vertices of the basic triangle will be described. A first major line is the longest side of the basic triangle, such as a first major line lo shown in FIG. 12, and is an opposing side of an interior angle IA having the largest angle of the basic triangle. In the basic triangle specified by the value stored in idx, a side connecting the vertex indicated by the vertex coordinates stored in the element vertices[3idx+1] of the array and the vertex indicated by the vertex coordinates stored in vertices[3idx+2] corresponds to the first major line l₀.

A second major line is the second longest side of the basic triangle, such as a second major line 11 shown in FIG. 12, and is an opposing side of an interior angle having an angle that is second largest following the largest angle in the basic triangle. In the basic triangle specified by the value stored in idx, a side connecting the vertex indicated by the vertex coordinates stored in the element vertices[3idx] of the array and the vertex indicated by the vertex coordinates stored in vertices[3idx+2] corresponds to the second major line l₁.

A third major line is the shortest side of the basic triangle, such as a third major line 12 shown in FIG. 12, and is an opposing side of an interior angle having the smallest angle of the basic triangle. In the basic triangle specified by the value stored in idx, a side connecting the vertex indicated by the vertex coordinates stored in the element vertices[3idx] of the array and the vertex indicated by the vertex coordinates stored in vertices[3idx+1] corresponds to the third major line l₂.

In addition, in the basic triangle, a vertex A_{B} is also referred to as a base point A_{B}. The base point A_{B} is a vertex that serves as an intersection between the first major line l₀ and the second major line l₁. A vertex A_{R} is also referred to as a right vertex A_{R}. The right vertex A_{R} is a vertex that serves as an intersection between the first major line l₀ and the third major line l₂. A vertex A_{L} is also referred to as a left vertex A_{L}. The left vertex A_{L} is a vertex that serves as an intersection between the second major line l₁ and the third major line

### <Operators>

Operators used in the description below will be described. floor(a) that is an operator is a function that returns a maximum integer that is equal to or less than a. ceil(a) is a function that returns a minimum integer that is equal to or greater than a. mod(a, b) is a function that returns a remainder in division of a by b. a/b expresses division of a by b. Here, float(a) means that a is expressed by a floating-point number. Here, a/b returns a value in which the remainder is truncated from the division result when a and b are integers. For example, 5/2=2. Meanwhile, in cases in which both a and b are floating-point numbers in a/b, as a result of division, for example, 5.0/2.0=2.5.

### <Overview of Processes>

First, at S21, the calculation apparatus 20 performs a major line process. In the major line process, the calculation apparatus 20 calculates a primary division number (such as M) for each basic triangle. M is an integer of M≥1. The primary division number is a number of divisions when the first major line is equally divided (based on, for example, a division length d₀ prescribed in advance) in each basic triangle. Equally divided herein includes a plurality of divisions of two or more, and a single division.

First major line points are a plurality (such as M+1) of points that are in positions equally dividing the first major line l₀ by the primary division number. The first major line points include both end points of the first major line l₀ (that is, the base point A_{B} and the right vertex A_{R}). That is, the first major line l₀ points include at least two first major line points. A first major line point number hereafter is a number of first major line points on the first major line (such as M+1, described above). In FIG. 12, an example in which four first major line points are included on the first major line l₀ of the basic triangle is given. Here, maj_vert_num, described hereafter, corresponds to the first major line point number.

Next, at S22, the calculation apparatus 20 performs a minor line process. In the minor line process, the calculation apparatus 20 sets a secondary division number (such as N) for each of the plurality of first major line points set on the first major line l₀. N is an integer of N≥0. The secondary division number is a number of divisions when a minor line set for each of the plurality of first major line points is equally divided (based on, for example, the above-described division length d₀). Equally divided herein includes a plurality of divisions of two or more, a single division, and zero division.

The minor line is a line segment that passes through the first major line point, and runs from the first major line l₀ to the second major line l₁ along the third major line l₂. The line segment that runs along the third major line l₂ is a line segment that is parallel to the third major line l₂. The line segment that runs along the third major line l₂ includes the third major line l₂ itself. The minor line includes a line segment that runs along the third major line l₂ and is set for the base point A_{B} that serves as a first major line point, and the third major line l₂ itself.

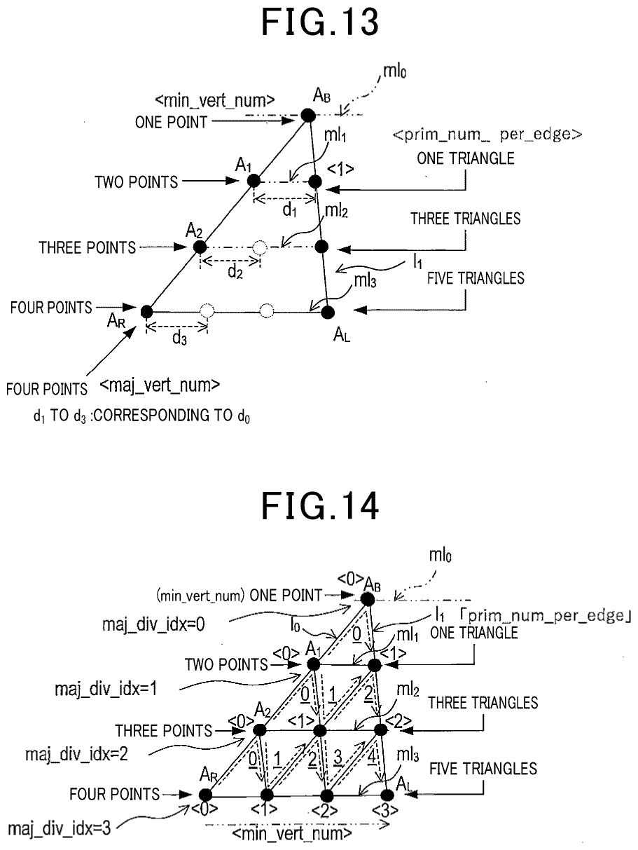

In an example in FIG. 13, the basic triangle has four minor lines (that is, ml₀ to ml₃) respectively set for four first major line points. The secondary division number of ml₀ is 0. The secondary division number of ml₁ is 1. The secondary division number of ml₂ is 2. The secondary division number of ml₃ is 3. The calculation apparatus 20 calculates the coordinates of the first major line points and the second major line points. Here, as described above, in the example in FIG. 13, ml₃ is the third major line l₂ and a minor line.

Next, at S23, the calculation apparatus 20 performs a subdivision process. In the subdivision process, the calculation apparatus 20 calculates the coordinates of the vertices of subdivided triangles for each minor line pair respectively set for the above-described first major line points using the array vertices[] after the above-described pre-shaping has been performed as a vertex coordinate group, the above-described primary division numbers, and combination information. The combination information is information specifying a combination method of the minor line points belonging to each subdivided triangle.

The minor line points are points that equally divide the minor line by the above-described secondary division number (such as N+1) and include both end points of the minor line. Both end points of the minor line are a point on the first major line and a point on the second major line positioned on both ends of the minor line. A minor line point number hereafter is a number of minor line points on the minor line (such as N+1, described above). maj_vert_num, described hereafter, corresponds to the minor line point number. Hereafter, an overview of a minor line pair, a number of subdivided triangles in a minor line pair, and the combination information will be described.

### <Regarding a Minor Line Pair>

The minor line pair is a combination of two arbitrary, adjacent minor lines among the minor lines. The subdivided triangle is one or more triangles that divide an area of a basic triangle sandwiched between the minor line pair without overlapping each other, with the minor line points on the two minor lines belonging to the minor line pair as vertices. Hereafter, the area of the basic triangle sandwiched between the minor line pair is also simply referred to as an area sandwiched between a minor line pair.

In addition, hereafter, the minor line set for each first major line point is also referred to as a reference minor line. According to the present embodiment, of the minor lines adjacent to the reference minor line, the minor line adjacent on the base point A_{B} side is referred to as an adjacent minor line. That is, the minor line pair is a combination of the reference minor line and the adjacent minor line. In addition, the subdivided triangle is one or more triangles that divide the area sandwiched between the minor line pair without overlapping each other, with the minor line points on the reference minor line and the minor line points on the adjacent minor line belonging to the minor line pair as vertices.

In the example in FIG. 13, the both end points of the minor line described above are a point on the first major line l₀ and a point on the second major line l₁. For example, regarding the above-described four minor lines (that is, ml₀ to ml₃), ml₀ may have one minor line point (that is, min_vert_num=1, described hereafter), ml₁ may have two minor line points (that is, min_vert_num=2), ml₂ may have three minor line points (that is, min_vert_num=3), and ml₃ may have four minor line points (that is, min_vert_num=4). The minor line point on the minor line ml₀ set for the base point A_{B} is one (that is, the base point A_{B}).

In the example in FIG. 13, regarding the right vertex A_{R} that serves as a first major line point, the minor line ml₃ set for the right vertex A_{R} and the minor line ml₂ set for the first major line point (also referred to, hereafter, as a point A₂) adjacent to the right vertex A_{R} on the base point A_{B} side are the minor line pair. In this minor line pair, ml₃ corresponds to the reference minor line and ml₂ corresponds to the adjacent minor line. Regarding the point A₂ that serves as a first major line point, the minor line ml₂ (that is, the reference minor line) set for the point A₂ and the minor line ml₁ (that is, the adjacent minor line) set for a point (also referred to, hereafter, as a point A₁) adjacent to the point A₂ on the base point A_{B} side are the minor line pair. In a similar manner, regarding the point A₁ that serves as a first major line point, the minor line ml₁ (that is, the reference minor line) set for the point A₁ and the minor line ml₀ (that is, the adjacent minor line) set for a point (that is, the base point A_{B}) adjacent to the point A₁ on the base point A_{B} side are the minor line pair.

Here, according to the present embodiment in which the minor line pairs are set in the basic triangle in order from the first major line point farthest from the base point A_{B} towards the base point A_{B}, the minor line set for the base point A_{B} that serves as a first major line point is not set as a reference minor line. That is, as shown in FIG. 13, three minor line pairs are set in the basic triangle serving as the example.

### <Regarding Number of Subdivided Triangles in Minor Line Pair>

For example, regarding the right vertex A_{R} that serves as the first major line point, described above, triangles that divide the area sandwiched between the minor line pair composed of the minor line ml₃ set for the right vertex A_{R} and the adjacent minor line ml₂ without overlapping each other may be the subdivided triangles. In the division, the minor line points on the two minor lines ml₃ (that is, the reference minor line) and ml₂ (that is, the adjacent minor line) belonging to the minor line pair serve as vertices of the subdivided triangles. In the example described above, as shown in FIG. 13, for example, the number of subdivided triangles dividing the area of the basic triangle sandwiched between the reference minor line ml₃ set for the right vertex A_{R} and the adjacent minor line ml₂ may be calculated to be 5.

Here, each of the subdivided triangles dividing the area of the basic triangle sandwiched between the minor line pair may be individually identified by an in-area identification number (that is, tess_prim_idx, described hereafter). The in-area identification number may be a number assigned to each subdivided triangle dividing the area sandwiched between the minor line pair, and may increase as the subdivided triangle becomes farther from the first major line with the first major line side as a starting point (that is, 0). For example, numbers that are underlined in FIG. 14 may correspond to the in-area identification numbers. For example, as shown in FIG. 13, for the subdivided triangles dividing the area sandwiched between the reference minor line ml₃ set for the right vertex A_{R} and the adjacent minor line ml₂, the in-area identification numbers may be set such as to 0, 1, 2, 3, and 4 in order from the first major line side.

### <Regarding Combination Information>

The above-described combination information specifies the combination method of the minor line points belonging to the subdivided triangles. Although details will be described hereafter, the combination information specifies the combination method of the minor line points belonging to the subdivided triangles in order from the subdivided triangle on the first major line side.

For example, regarding the minor line pair composed of the reference minor line ml₃ and the adjacent minor line ml₂, first, the combination method of the minor line points may be specified in the following manner for a first subdivided triangle when viewed from the first major line. The first subdivided triangle when viewed from the first major line is a subdivided triangle having the in-area identification number=0. That is, a first minor line point is the minor line point on ml₃ that is also the first minor line point when viewed from the first major line. A second minor line point is the minor line point on ml₂ that is also the first minor line point when viewed from the first major line. A third minor line point is the minor line point on ml₃ that is also the second minor line point when viewed from the first major line.

In addition, the combination information specifies the combination method of the minor line points in the following manner for a second subdivided triangle when viewed from the first major line. The second subdivided triangle when viewed from the first major line is a subdivided triangle having the in-area identification number=1. That is, the first minor line point is the minor line point on ml₂ that is also the first minor line point when viewed from the first major line. The second minor line point is the minor line point on ml₃ that is also the second minor line point when viewed from the first major line. The third minor line point is the minor line point on ml₂ that is also the second minor line point when viewed from the first major line.

Regarding a third subdivided triangle when viewed from the first major line, the combination information specifies the combination method of the minor line points in a manner similar to that for the first subdivided triangle, that is, so as to form a triangle that projects toward the base point A_{B} side. The third subdivided triangle when viewed from the first major line is a subdivided triangle having the in-area identification number=2. That is, the first minor line point is the minor line point on ml₃ that is also the second minor line point when viewed from the first major line. The second minor line point is the minor line point on ml₂ that is also the second minor line point when viewed from the first major line. The third minor line point is the minor line point on ml₃ that is also the third minor line point when viewed from the first major line. At this time, the minor line point specified first is a minor point line that is adjacent to the minor line point that is specified first in the first subdivided triangle in a direction along the minor line (that is, a direction away from the first major line).

Regarding a fourth subdivided triangle when viewed from the first major line, the combination information specifies the combination method of the minor line points in a manner similar to that for the second subdivided triangle, that is, so as to form a triangle that projects toward the side opposite the base point A_{B}. The fourth subdivided triangle when viewed from the first major line is a subdivided triangle having the in-area identification number=3. That is, the first minor line point is the minor line point on ml₂ that is also the second minor line point when viewed from the first major line. The second minor line point is the minor line point on ml₃ that is also the third minor line point when viewed from the first major line. The third minor line is the minor line point on ml₂ that is also the third minor line point when viewed from the first major line. At this time, the minor line point specified first is a minor point line that is adjacent to the minor line point that is specified first in the second subdivided triangle in the direction along the minor line (that is, the direction away from the first major line). This similarly applies hereafter.

That is, as indicated by dotted arrow lines in FIG. 14, for example, the combination method of the minor line points may be specified for each minor line pair. In other words, for example, when the in-area identification number is an even number, the combination information may specify the combination method of the minor line points so that a triangle that projects towards the base point A_{B} side is formed (also referred to, hereafter, as a first specified pattern). In addition, when the in-area identification number is an odd number, the combination information may specify the combination method of the minor line points so that a triangle that projects towards the side opposite the base point A_{B} is formed (also referred to, hereafter, as a second specified pattern).

Each minor line point can be identified by a primary division point identification number (that is, maj_div_idx, described hereafter) and a secondary division point identification number (that is, maj_div_idx, described hereafter) described hereafter. As described hereafter, the combination information identifies the subdivided triangles dividing the area sandwiched between the minor line pair by the in-area identification numbers, and specifies the combination method of the minor line points belonging to the identified subdivided triangle based on the primary division point identification number and the secondary division point identification number. Here, as described hereafter, the combination information may specify the combination method of the minor line points belonging to the subdivided triangle based on a displacement amount of the primary division point identification number and a displacement amount of the secondary division point identification number.

According to the present embodiment, the calculation apparatus 20 generates the combination information specifying the combination method of the minor line points belonging to the subdivided triangle as described above. The calculation apparatus 20 calculates the coordinates of the vertices of the subdivided triangles for each minor line pair set for each first major line point using the vertex coordinate group, the primary division number, and the combination information. The calculation apparatus 20 generates the subdivided triangles for all basic triangles, or in other words, all first major line points and ends multi-stage division.

### [1-2-3. Details of Multi-Stage Division]

Details of the multi-stage division will be specifically described.

### (1) Major Line Process

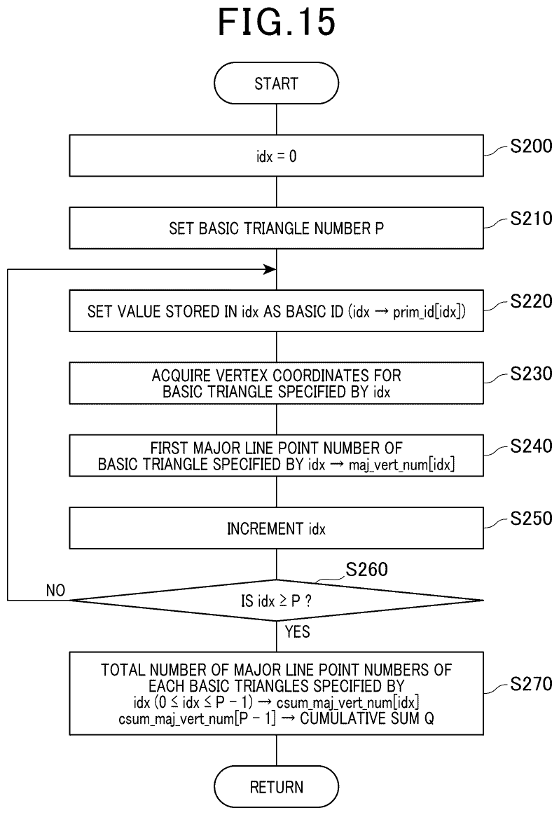

The major line process performed at S21 in multi-stage division will be described with reference to a flowchart in FIG. 15. In the present process, the following array is outputted with the array vertices[] after the above-described pre-shaping has been performed as an input array. The array being outputted refers to an array being generated (that is, values being stored in the elements of the array). The array that is outputted is also referred to as an output array. The output arrays are an array prim_id[idx], an array maj_vert_num[idx], and an array csum_maj_vert_num[idx].

Here, the variable idx (written, hereafter, as idx) is within a range of 0≤idx≤P−1. A total number of idx used in the present process is equal to a total number of basic triangles (also referred to, hereafter, as a basic triangle number P) defined by the vertex coordinates stored in the array vertices[]. Here, for differentiation, idx used in the major line process is also written as idx p hereafter.

### <Description of Arrays>

The array prim_id[idx] is an array that stores a value (also referred to, hereafter, as a basic ID) corresponding to an identification number for identifying each basic triangle, for the basic triangle specified by idx among the basic triangles defined by the vertex coordinates stored in the array vertices[]. The array maj_vert_num[idx] is an array that stores the above-described first major line point number for the basic triangle specified by idx. Here, in a manner similar to the description for multi-stage division, for example, the elements of the array may simply be written as prim_id hereafter.

Here, the element vertices[] of the array is expressed by a floating-point number, the element prim_id[] of the array is expressed by an integer of 0 or greater, and the element maj_vert_num[] of the array is expressed by a positive integer.

### <Processes>

First, at S200, the calculation apparatus 20 stores 0 in idx.

Next, at S210, the calculation apparatus 20 sets the basic triangle number P. The calculation apparatus 20 stores the number of basic triangles defined by the vertex coordinates stored in the array vertices[] after the pre-shaping process has been performed in the basic triangle number P. The basic triangle number P corresponds to a number of loops (that is, a number of repetitions) of the processes at S220 to S260, described hereafter.

First, at S220, the calculation apparatus 20 stores the value stored in idx in the array prim_id[idx]. For example, when idx=0, 0 may be stored as the element prim_id[0] of the array and 0 may be set as the basic ID of the first basic triangle defined by the array vertices[].

Next, at S230, the calculation apparatus 20 acquires the vertex coordinates of the basic triangle specified by the value stored idx. That is, the calculation apparatus 20 acquires the elements vertices[3idx], vertices[3idx+1], and vertices[3idx+2] of the array.

At subsequent S240, the calculation apparatus 20 calculates the first major line point number for the basic triangle specified by the value stored in idx. As described above, the first major line points include the vertices A_{B} and A_{R} on both ends of the first major line lo, as shown in FIG. 12, described above. The calculation apparatus 20 calculates the first major line point number based on expression (2) and stores the calculated number in the array maj_vert_num[idx].

$$maj\_vert \_num [ idx ] = ceil ( length of longest side of triangle / division length ) + 1 \qquad ( 2 )$$

The first term in expression (2) corresponds to the primary division number described above. That is, the calculation apparatus 20 calculates a value obtained by dividing the length of the first major line by a division length d₀, rounds the calculated value to a nearest integer equal to or greater than the calculated value, and calculates a value obtained by adding 1 to the rounded value as the first major line point number. Because the rounded value is used, an interval between the first major line points is a length corresponding to the division length d₀. The length corresponding to the division length d₀ may not strictly be a length coinciding with the division length d₀ but rather be a length within a predetermined range including the division length d₀. The division length d₀ may be stored in a memory such as the ROM 23 in advance. The division length d₀ is a value that may be set as appropriate based on intended use (such as required accuracy of computer graphics). The first major line point number is calculated as an integer of 2 or greater by expression (2).

A length of the first major line is calculated based on the vertex coordinates stored in the elements vertices[3idx], vertices[3idx+1], and vertices[3idx+2]. For example, when the value stored in idx is 0, the value indicating the first major line point number may be stored as the element maj_vert_num[0] of the array for the basic triangle of which 0 stored in the element prim_id[0] of the array is the basic ID.

Next, at S250, the calculation apparatus 20 increments idx. That is, the calculation apparatus 20 stores, in idx, a value obtained by adding 1 to the value stored in idx. At subsequent S260, the calculation apparatus 20 determines whether the value stored in idx is equal to or greater than the basic triangle number P. Here, when the value stored in idx is equal to or greater than the basic triangle number P, the process transitions to S270.

Meanwhile, when the value stored in idx is less than the basic triangle number P, the calculation apparatus 20 transitions to S220 and repeats the processes at S220 to S260 based on the value that is newly stored in idx.

At S270, for example, the calculation apparatus 20 may calculate the total number of the elements maj_vert_num[idx] of the array by changing idx by 1 each time within the range of 0≤idx≤P−1, and store the calculated total number in csum_maj_vert_num[idx]. A total number of the total number of the elements maj_vert_num[idx] of the array is a total sum of the elements maj_vert_num[0] to maj_vert_num[idx] of the array.

The element csum_maj_vert_num[P−1] of the array when P−1 is stored in idx corresponds to a total number Q (also referred to, hereafter, as a cumulative sum Q) of the first major line points included in all P number of basic triangles. Then, the calculation apparatus 20 thereby ends the major line process.

### <Workings>

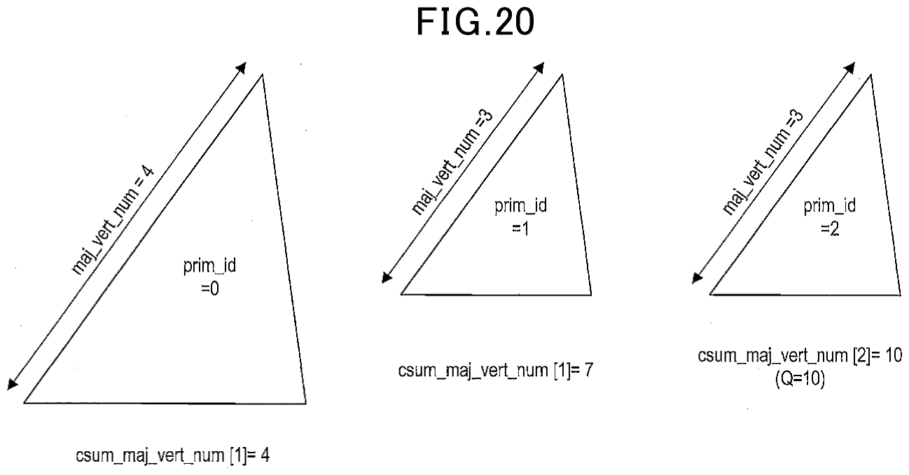

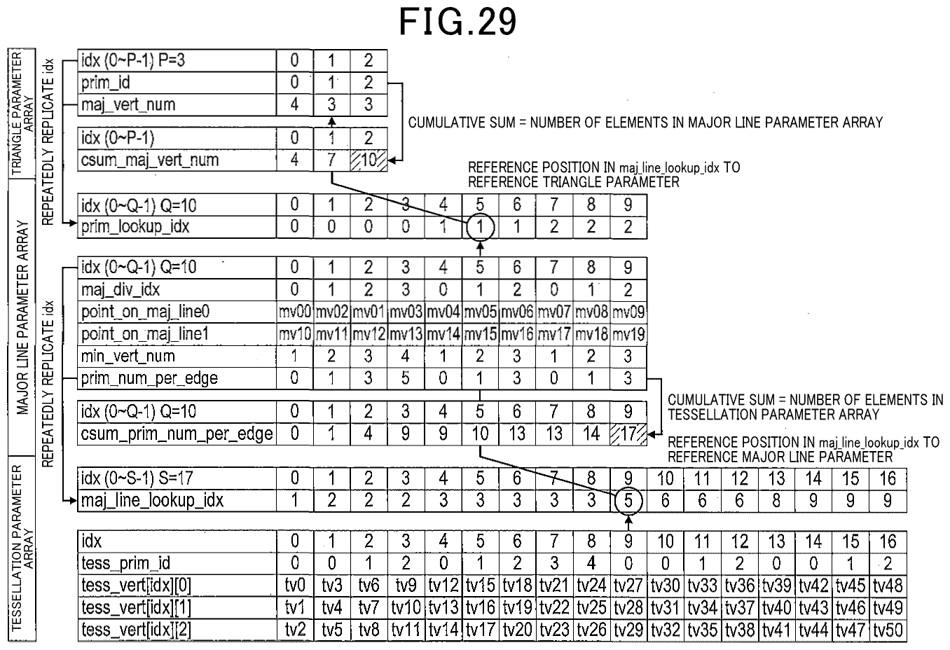

An example of workings of the major line process will be described with reference to FIG. 20 and FIG. 29. In FIG. 20, an example in which the basic triangle number P=3 will be described. When the loop number of the major line process is equivalent to the value stored in the basic triangle number P as described above, values are stored in arrays prim_id[0] to prim_id[P−1] (for example, P=2) as a result of S220 being repeated. In the example in FIG. 20, as shown in FIGS. 29, 0, 1, and 2 are respectively stored as the elements prim_id[0] to prim_id[2] of the array, and basic IDs 0, 1, and 2 are set in order from the first triangle.

In addition, as a result of S240 being repeated, when the first major line point number is calculated for each basic triangle as shown in FIG. 20, for example, 4, 3, and 3 are respectively stored as the elements maj_vert_num[0] to maj_vert_num[2] of the array as shown in FIG. 29.

In addition, as a result of S270 being performed, as shown in FIGS. 29, 4, 7, and 10 are respectively stored as the elements csum_maj_vert_num[0] to csum_maj_vert_num[2] of the array. That is, 10 that is the value stored as the element csum_maj_vert_num [P−1] (for example P=3) of the array is calculated as the total number Q (that is, the cumulative sum Q) of the first major line points of all of the basic triangles.

Here, the array prim_id[], and the arrays maj_vert_num[] and csum_maj_vert_num[] are also, hereafter, collectively referred to as a triangle parameter array.

### (2) Minor Line Process

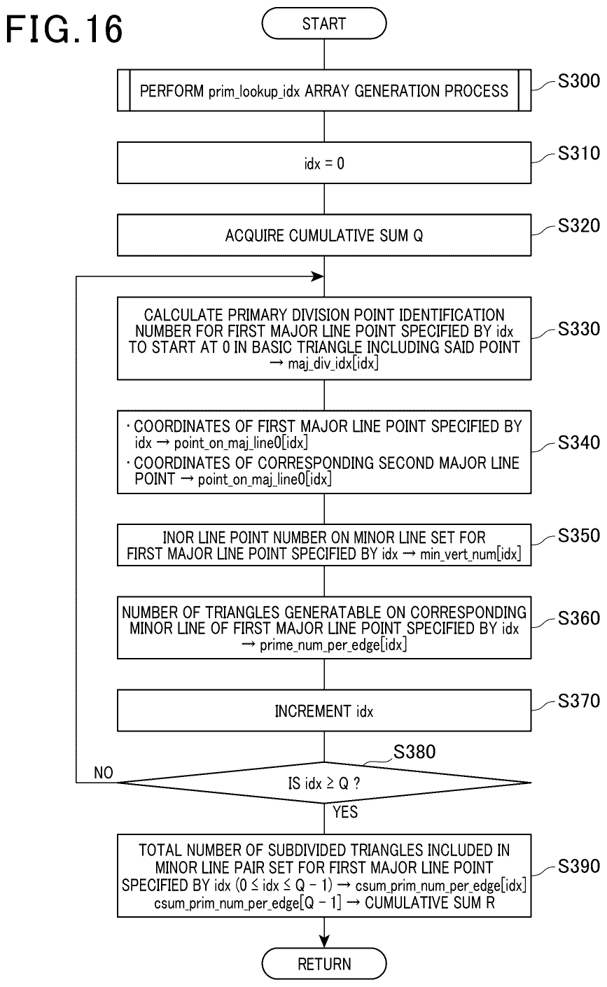

The minor line process performed at S22 in multi-stage division will be described with reference to a flowchart in FIG. 16. In the present process, the following array is the output array with the array vertices[] and the above-described triangle parameter array as the input arrays.

The output arrays are an array prim_lookup_idx[idx], an array maj_div_idx[idx], an array point_on_maj_line0[idx], an array point_on_maj_line1[idx], an array min_vert_num [idx], an array prim_num_per_edge[idx], and an array csum_prim_num_per_edge[idx].

Here, idx indicating an element of the array has a range of 0≤idx≤Q−1. A total number of idx used in the present process is equivalent to the total number Q (that is, the cumulative sum Q) of the first major line points included in all of the basic triangles. Here, for differentiation, idx used in the minor line process may also be written as idx_m hereafter.

### <Description of Arrays>

The array prim_lookup_idx[idx] is a so-called lookup table used to reference the above-described triangle parameter array while the minor line process is being performed. In other words, the prim_lookup_idx[idx] is correspondence information associating one first major line point specified by idx (that is, idx_m) and the basic ID (that is, idx_p) of the basic triangle including the first major line point.

The array maj_div_idx[idx] stores the primary division point identification number for the first major line point specified by the value stored in idx (that is, idx_m).

The array point_on_maj_line0[idx] stores the position vector of the first major line point specified by the value stored in idx (that is, idx_m). Regarding the first major line point specified by the value stored in idx (that is, idx_m), the array point_on_maj_line1[idx] stores the position vector of a second major line point corresponding to the first major line point. The second major line points are points in positions equally dividing the second major line at a same division ratio as a division ratio at which the first major line is divided.

Regarding the first major line point specified by the value stored in idx (that is, idx_m), the array min_vert_num[idx] stores the minor line point number of the minor line set for the first major line point.

Regarding the first major line point specified by the value stored in idx (that is, idx_m), the array prim_num_per_edge[idx] stores the number of above-described subdivided triangles dividing the area sandwiched between the minor line pair set for the first major line point using the minor line points.

Here, an element prim_lookup_idx[] of the array, an element maj_div_idx [] of the array, an element prim_num_per_edge[] of the array, and an element csum_prim_num_per_edge[] of the array are expressed as integers of 0 or greater. An element min_vert_num[] of the array is expressed as a positive integer. An element point_on_maj_line0[] of the array and an element point_on_maj_line1[] of the array are expressed by floating-point numbers.

### <Processes>

First, at S300, the calculation apparatus 20 performs a prim_lookup_idx array generation process to generate the array prim_lookup_idx[idx].

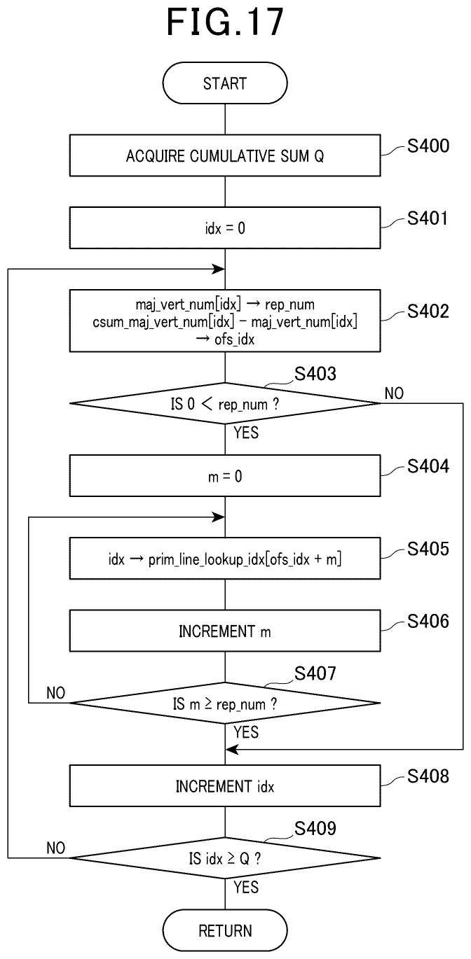

In the prim_lookup_idx array generation process, as shown in FIG. 17, first, at S400, the calculation apparatus 20 acquires the cumulative sum Q. Next, at S401, the calculation apparatus 20 stores 0 in idx.

At subsequent S402, the calculation apparatus 20 stores the element maj_vert_num[idx] of the array in a variable rep_num. In addition, the calculation apparatus 20 stores a difference between the element csum_maj_vert_num[idx] of the array and the element maj_vert_num[idx] of the array in a variable ofs_idx.

Next, at S403, the calculation apparatus 20 determines whether the value stored in rep_num is greater than 0. When the value stored in rep_num is greater than 0, the calculation apparatus 20 transitions the process to S404. When the value stored in rep_num is equal to or less than 0, the calculation apparatus 20 transitions the process to S408.

At S404, the calculation apparatus 20 stores 0 in the variable m.

Next, at S405, the calculation apparatus 20 stores the value stored in idx as the element prim_lookup_idx[ofs_idx+m] of the array specified by [ofs_idx+m].

At subsequent S406, the calculation apparatus 20 increments the variable m. That is, the calculation apparatus 20 stores, in the variable m, a value obtained by adding 1 to the value stored in the variable m.

Next, at S407, the calculation apparatus 20 determines whether the value stored in the variable m is equal to or greater than the value stored in rep_num. Here, when the value stored in the variable m is equal to or greater than the value stored in rep_num, the process is transitioned to S408.

Meanwhile, when determined that the value stored in the variable m is less than the value stored in rep_num, the calculation apparatus 20 transitions to S405 and repeats the processes at S405 to S407 based on the value newly stored in the variable m.

At S408, the calculation apparatus 20 increments idx. That is, the calculation apparatus 20 stores, in idx, a value obtained by adding 1 to the value stored in idx.

Next, at S409, the calculation apparatus 20 determines whether the value stored in idx is equal to or greater than the cumulative sum Q. Here, when the value stored in idx is equal to or greater than the cumulative sum Q, the present prim_lookup_idx array generation process is thereby ended.

Meanwhile, when the value stored in idx is less than the cumulative sum Q, the calculation apparatus 20 transitions to S402 and repeats the processes at S402 to S409 based on the value newly stored in idx. Then, when the value stored in idx is equal to or greater than the cumulative sum Q, the calculation apparatus 20 thereby ends the present prim_lookup_idx array generation process.

Returning to FIG. 16, the description will be continued.

At S310, the calculation apparatus 20 stores 0 in idx.

Next, at S320, the calculation apparatus 20 acquires the total value Q (that is, the cumulative sum Q) of the first major line points. The cumulative sum Q corresponds to the loop number (that is, the number of repetitions) of S350 to S380 described hereafter.

First, at S330, the calculation apparatus 20 calculates the primary division point identification number for the first major line point specified by the value stored in idx. The primary division point identification number is the number assigned to each first major line point in the basic triangle including the first major line point specified by idx. According to the present embodiment, the primary division point identification number is a number that starts in order from the base point A_{B} that is a vertex of the basic triangle and connects the first major line and the second major line, with the base point A_{B} as 0, and increases from the base point A_{B} toward the right vertex A_{R}. The calculation apparatus 20 stores the calculated primary division point identification number in the array maj_div_idx[idx]. The primary division point identification number, that is, the element maj_div_idx[idx] of the array is calculated based on expression (3) and expression (4).

$$lookup\_idx = prim\_lookup \_id [ idx ] \qquad ( 3 )$$

$$maj\_div \_idx [ idx ] = idx - csum\_maj \_vert \_num [ lookup\_idx ] + maj\_vert \_num [ lookup\_idx ] \qquad ( 4 )$$

Lookup_idx indicated in expression (3) corresponds to an index (that is, idx_p) for specifying the triangle parameter array to be referenced.

Next, at S340, the calculation apparatus 20 calculates the position vector of the first major line point specified by the value stored in idx and stores the position vector in the array point_on_maj_line0[idx]. In addition, the calculation apparatus 20 calculates the position vector of the second major line point corresponding to the first major line point specified by the value stored in idx and stores the position vector in the array point_on_maj_line1[idx]. Corresponding herein refers to a place in order when counting from the base point A_{B} being the same.

The coordinates of the first major line point are calculated by the first major line being divided at a ratio maj_div_idx[idx]/maj_vert_num[idx]. In a similar manner, the coordinates of the second major line point are calculated by the second major line being divided at a ratio maj_div_idx[idx]/maj_vert_num[idx]. Here, when the first major line point specified by the value stored in idx is the base point A_{B}, the coordinates of the first major line point and the coordinates of the second major line point corresponding thereto coincide.

First, the calculation apparatus 20 calculates lookup_idx in a manner similar to expression (3) described above.

Next, the calculation apparatus 20 stores the coordinates of the base point A_{B} in a variable org based on expression (5).

$$org = vertices [ 3 * lookup\_idx + 2 ] \qquad ( 5 )$$

Next, the calculation apparatus 20 calculates a side vector edge0 of the first major line that is the longest side and a side vector edge of the second major line that is the second longest side based on expression (6) and expression (7).

$$edge 0 = vertices [ 3 * lookup\_idx + 1 ] - vertices [ 3 * lookup\_idx + 2 ] \qquad ( 6 )$$

$$edge 1 = vertices [ 3 * lookup\_idx + 0 ] - vertices [ 3 * lookup\_idx + 2 ] \qquad ( 7 )$$

Then, the calculation apparatus 20 calculates the coordinates of the first major line point with reference to the base point A_{B} (that is, the vertex of which the opposing side is the third major line that is the shortest side) based on expression (8), and stores the coordinates in the array point_on_maj_line0[idx]. In a similar manner, the calculation apparatus 20 calculates the coordinates of the second major line point with reference to the base point A_{B} based on expression (9) and stores the coordinates in the array point_on_maj_line1[idx].

$$point\_on \_maj \_line0 [ idx ] = org + ( ( float ) maj\_div \_idx / ( float ) ( maj\_vert \_num - 1 ) ) * edge 0 \qquad ( 8 )$$

$$point\_on \_maj \_line1 [ idx ] = org + ( ( float ) maj\_div \_idx / ( float ) ( maj\_vert \_num - 1 ) ) * edge 1 \qquad ( 9 )$$

At subsequent S350, regarding the first major line point specified by the value stored in idx, the calculation apparatus 20 calculates the minor line point number of the minor line set for this point. The calculation apparatus 20 stores the calculated minor line point number in the array min_vert_num[idx]. The length of the minor line is calculated based on the element point_on_maj_line0[idx] of the array and the element point_on_maj_line1[idx] of the array. That is, the element min_vert_num[idx] of the array is calculated by expression (10) below in a manner similar to the above-described array maj_vert_num[idx].

$$min\_vert \_num [ idx ] = ceil ( ( point\_on \_maj \_line1 [ idx ] - point\_on \_maj \_line0 [ idx ] / ( division length ) + 1 \qquad ( 10 )$$

The first term in expression (10) corresponds to the secondary division number described above. Here, of the first major line points specified by the value stored in idx, the first major line point of which the element maj_dev_idx [idx] of the array is 0 corresponds to the base point AB. For the base point AB, 1 is stored as the element min_vert_num [idx] of the array.

At subsequent S360, regarding the first major line point specified by the value stored in idx, the calculation apparatus 20 calculates the number of subdivided triangles dividing the area sandwiched between the minor line pair for each minor line pair set for this point. The calculation apparatus 20 stores the calculated number in the array prim_num_per_edge[idx]. Here, a reference minor line point referred to below is a minor line point on the reference minor line. An adjacent minor line point is a minor line point on the adjacent minor line. That is, the adjacent minor line point refers to a minor line point on the minor line adjacent on the base point A_{B} side of the minor line (that is, the reference minor line) set for the first major line specified by the value stored in idx. According to the present embodiment, of the two minor lines forming a pair, the minor line set for the first major line point having the greater maj_div_idx is the reference minor line.

In the area of the basic triangle sandwiched between the reference minor line and the adjacent minor line forming a pair, the number of vertices configuring the subdivided triangles is a total value of the reference minor line points and the adjacent minor line points. Focusing on the case in which 0 is stored in idx, the number of subdivided triangles dividing the area sandwiched between the minor line pairs is calculated based on expression (11). The calculated value is stored in the array prim_per_edge[idx].

$$if ( idx == 0 ) \{ prim\_num \_per \_edge [ idex ] = 0 ; \} \qquad ( 11 )$$

$$else \{ prim\_num \_per \_edge [ idex ] = min\_vert \_num [ idx ] + min\_vert \_num [ idx - 1 ] - 2 ; \}$$

Next, at S370, the calculation apparatus 20 increments idx. That is, the calculation apparatus 20 stores, in idx, a value obtained by adding 1 to the value stored in idx.

At subsequent S380, the calculation apparatus 20 determines whether the value stored in idx is equal to or greater than the cumulative sum Q. Here, when determined that the value stored in idx is equal to or greater than the cumulative sum Q, the calculation apparatus 20 transitions the process to S390.

Meanwhile, when determined that the value stored in idx is less than the cumulative sum Q, the calculation apparatus 20 transitions to S330 and repeats the processes at S330 to S380 based on the value newly stored in idx.

At S390, for example, the calculation apparatus 20 may change idx by 1 each time within a range of 0≤idx≤Q−1, calculate the total number of the element prim_num_per_edge[idx] of the array, and store the calculated total number in the array csum_prim_num_per_edge[idx]. The total number of the element prim_num_per_edge [idx] of the array is the total sum of the elements prim_num_per_edge[0] to prim_num_per_edge[idx].

The element csum_prim_num_per_edge [Q−1] of the array when Q−1 is stored in idx corresponds to a total number R (also referred to, hereafter, as a cumulative sum R) of the subdivided triangles dividing the areas sandwiched between the minor line pairs set for all Q number of first major line points. In other words, the cumulative sum R is the total number of subdivided triangles included in all basic triangles (that is, the P number of triangles). The calculation apparatus 20 then ends the minor line process.

### <Workings>

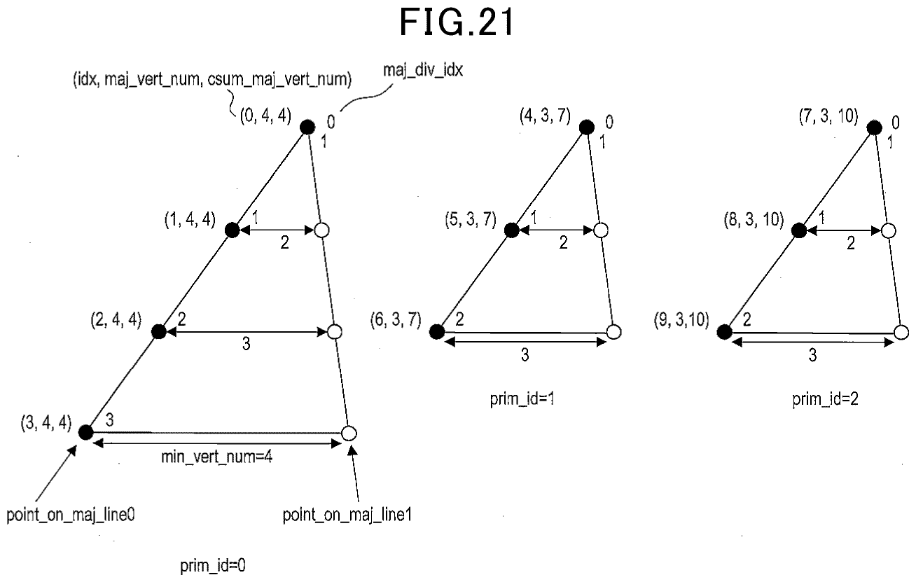

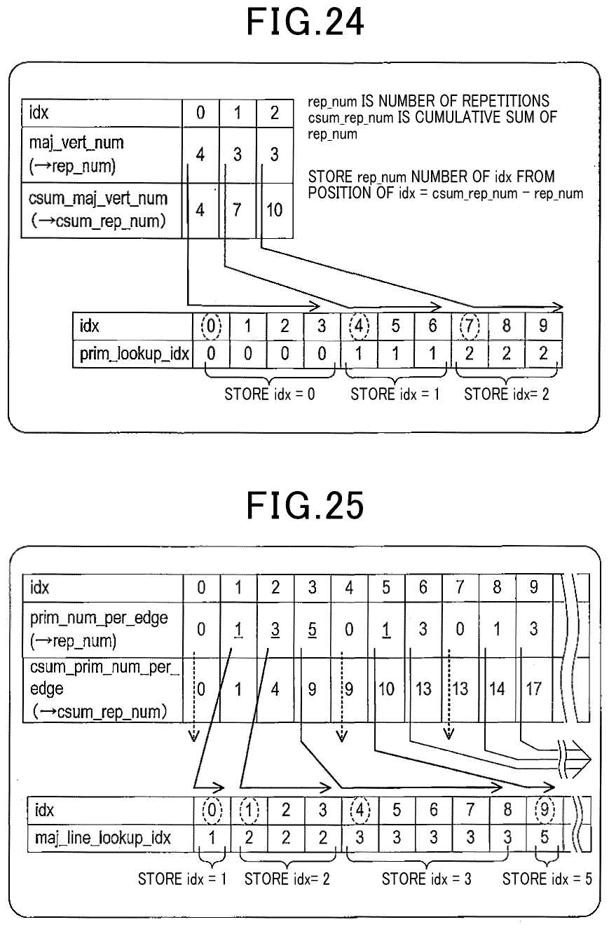

Workings of the minor line process will be described with reference to FIG. 20 to FIG. 22, FIG. 24, and FIG. 29. When the loop number is the cumulative sum Q as described above, as a result of S300, values are stored in the elements prim_lookup_idx [0] to prim_lookup_idx[Q−1] of the array. For example, as shown in FIG. 21, when the first major line points are arranged with Q=10, as shown in FIG. 24 and FIGS. 29, 0, 0, 0, 0, 1, 1, 1, 2, 2, and 2 may be respectively stored as the elements prim_lookup_idx[0] to prim_lookup_idx[9] of the array. That is, an index (that is, the basic ID) when the triangle parameter array is reference is stored for each first major line point.

In addition, as a result of S330 being repeated, as shown in FIG. 21 and FIGS. 29, 0, 1, 2, 3, 0, 1, 2, 0, 1, and 2 are respectively stored as the elements maj_div_idx[0] to maj_div_idx[9] of the array. That is, for each basic triangle, the primary division point identification numbers are set in order with the basic point A_{B} as 0 for each first major line point.

In addition, as a result of S340 being repeated, as shown in FIG. 29, mv00, mv01, . . . mv09 are respectively stored as the elements point_on_maj_line0[0] to point_on_maj_line0[9] of the array. In a similar manner, mv10, mv11, . . . mv19 are respectively stored as the elements point_on_maj_line1[0] to point_on_maj_line1[9] of the array.

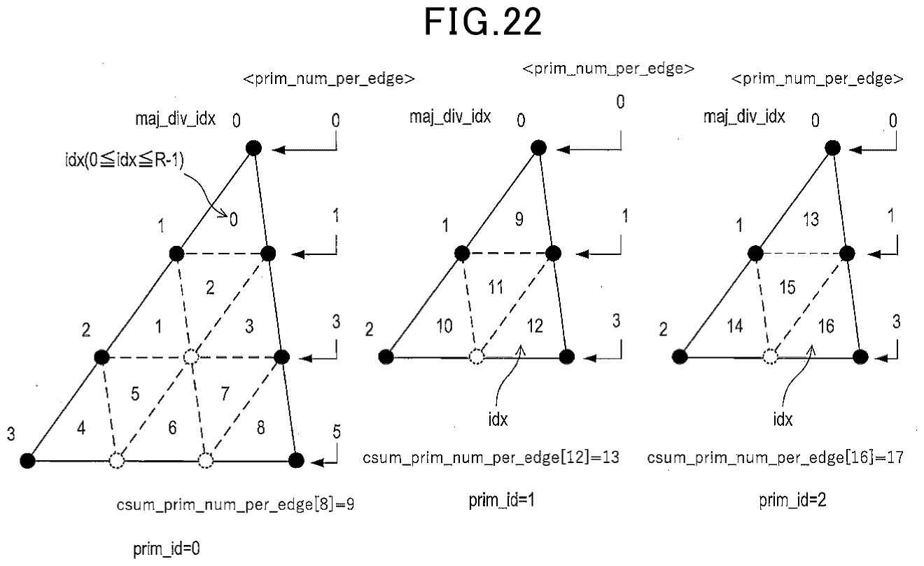

In addition, as a result of S350 being repeated, as shown in FIG. 21 and FIGS. 29, 1, 2, 3, 4, 1, 2, 3, 1, 2, and 3 are respectively stored as the elements min_vert_num[0] to min_vert_num[9] (that is, the minor line points) of the array. In addition, as a result of S360 being repeated, as shown in FIG. 22 and FIGS. 29, 0, 1, 3, 5, 0, 1, 3, 0, 1, and 3 are respectively stored as the elements prim_num_per_edge[0] to prim_num_per_edge[9].

For example, in the basic triangle specified by prim_id=0 shown in FIG. 21, the first major line point specified by idx=3 may be the right vertex AR. In this case, the number of subdivided triangles dividing the area sandwiched between the minor line pair is 5 as shown in FIGS. 22, and 5 is stored in prim_num_per_edge[3] as shown in FIG. 29. In the minor line pair, the reference line is the minor line set for the first major line point specified by idx=3, and the adjacent minor line is the minor line set for the first major line point specified by idx=2.

In addition, as a result of S390 being performed, as shown in FIG. 22 and FIGS. 29, 0, 1, 4, 9, 9, 10, 13, 13, 14, and 17 are respectively stored as the elements csum prim_num_per_edge[0] to csum_prim_num_per_edge[9] of the array.

In the examples in FIG. 20 to FIG. 22, 17 that is the value stored as the element csum_maj_vert_num[9] of the array corresponds to the total number (that is, the cumulative sum R) of the subdivided triangles dividing the areas sandwiched between the minor line pairs set for the nine (that is, Q=9) first major line points. In other words, 17 corresponds to the subdivided triangle total number R included in all three (that is, P=3) basic triangles shown in FIG. 20 to FIG. 22.

Here, the array prim_lookup_idx[idx], the array maj_div_idx[idx], the array point_on_maj_line0[idx], the array point_on_maj_line1[idx], the array min_vert_num[idx], the array prim_num_per_edge[idx], and the array csum prim_num_per_edge[idx] are also collectively referred to hereafter as a major line parameter array.

### (3) Subdivision Process

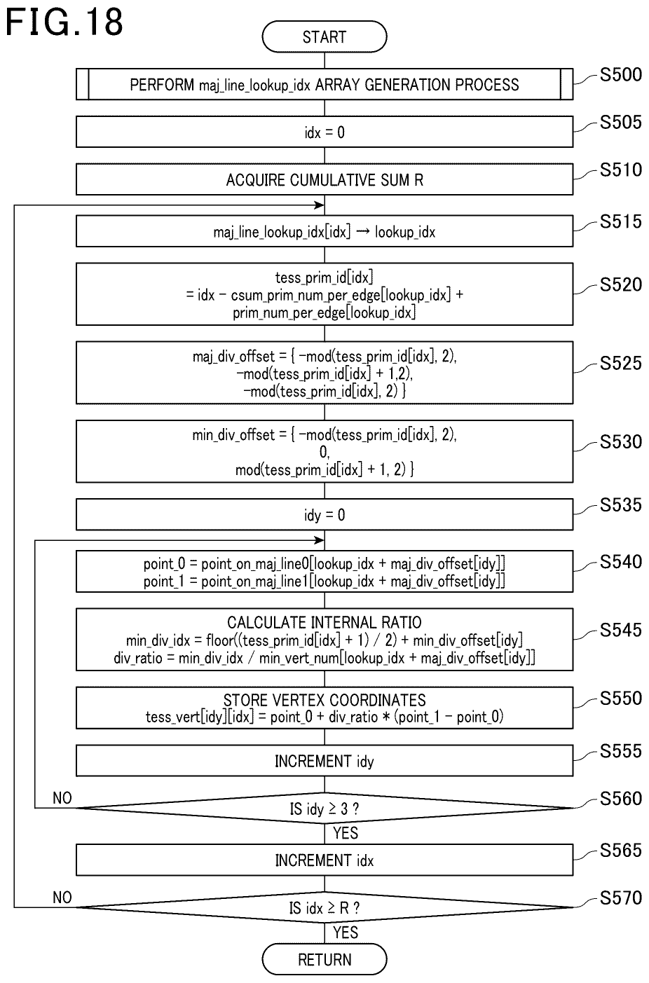

The subdivision process performed at S23 in multi-stage division will be described with reference to a flowchart in FIG. 18. In the present process, the above-described major line parameter array is an input array and an array below is the output array. The output array is an array maj_line_lookup_idx[idx] and an array tess_vert[idx].

Here, idx indicating an element in the array is within a range of 0≤idx≤R−1. The total number of idx used in the present process is equivalent to the subdivided triangle total number R (that is, the cumulative sum R) of all basic triangles. Here, idx used in the subdivision process is also written as idx_sub hereafter for differentiation.

### <Description of Arrays>

The array maj_line_lookup_idx[idx] is a lookup table used to reference the above-described major line parameter array while the subdivision process is performed. In other words, the array maj_line_lookup_idx[idx] is corresponding information for associating one subdivided triangle specified by idx (that is, idx_sub) and a number (that is, idx_m) identifying the first major line point for which the minor line pair including the subdivided triangle is set.

The array tess_vert[idx] stores the vertex coordinates of the subdivided triangle specified by the value stored in idx (that is, idx_sub). The elements tess_vert[3idx], tess_vert[3idx+1], and tess_vert[3idx+2] of the array respectively indicate three vertex coordinates of one subdivided triangle. Here, in a manner similar to the above-described array vertices[], the array tess_vert[idx] may be written as tess_vert[idy][idx]. idy is within a range of 0≤idy≤2. That is, tess_vert[0][idx] stores the vertex coordinates specified first for the subdivided triangle specified by the value stored in idx. In a similar manner, tess_vert[1][idx] stores the vertex coordinates specified second for the subdivided triangle specified by the value stored in idx, and tess_vert[2][idx] stores the vertex coordinates specified third for the subdivided triangle specified by the value stored in idx.

Here, the element maj_line_lookup_idx[idx] of the array is expressed as an integer of 0 or greater and the element tess_vert[idx] of the array is expressed by a floating-point number.

### <Processes>

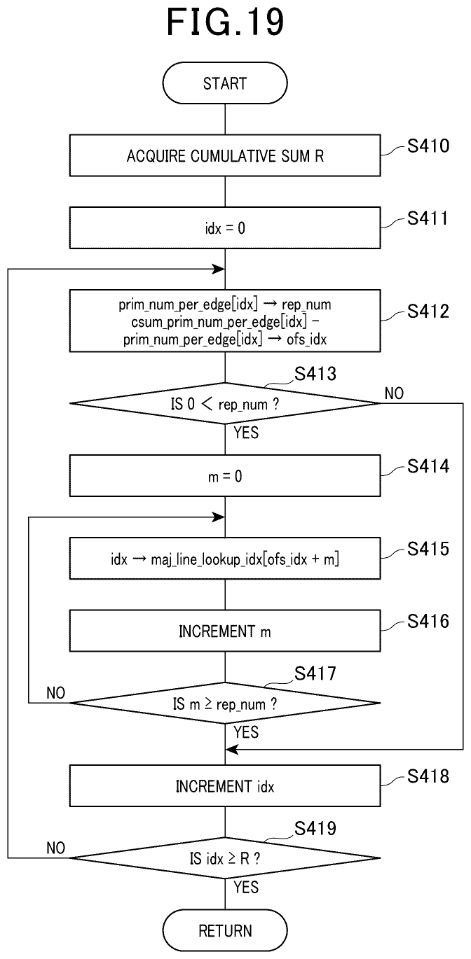

As shown in FIG. 18, first, at S500, the calculation apparatus 20 performs a maj_line_lookup_idx array generation process to generate the array maj_line_lookup_idx[idx]. As shown in FIG. 19, in the maj_line_lookup_idx array generation process, S410, S412, S415, and S419 differ from those of the prim_lookup_idx array generation process shown in FIG. 17. Other steps are similar and, therefore, descriptions thereof are omitted herein. That is, the cumulative sum R is used instead of the cumulative sum Q in the prim_lookup_idx array generation process, and prim_num_per_edge[] is used instead of the array maj_vert_num[]. In addition, the array csum_prim_num_per_edge[] is used instead of the array csum_maj_vert_num[]. As a result, the array maj_line_lookup_idx[idx] is outputted. Returning to FIG. 18, the description will be continued.

At S505, the calculation apparatus 20 stores 0 in idx.

Next, at S510, the calculation apparatus 20 acquires the subdivided triangle total number R (that is, the cumulative sum R). The cumulative sum R corresponds to the loop number (that is, the number of repetitions) of S515 to S570.

At S515 to S570, the calculation apparatus 20 calculates the vertex coordinates of the subdivided triangle specified by the value stored in idx, and stores the calculated vertex coordinates in tess_vert[idy][idx].

First, at S515, as shown in expression (12), the calculation apparatus 20 stores, in variable lookup_idx, a value of the index (that is, idx_m) used to reference the major line parameter array for the subdivided triangle specified by the value stored in idx (that is, idx_sub).

$$lookup\_idx = maj\_line \_lookup \_idx [ idx ] \qquad ( 12 )$$

As a result, the major line parameter related to the subdivided triangle specified by the value stored in idx (that is, idx_sub) can be specified. That is, the major line parameter array is not required to be newly read. The major line parameter already stored in the memory can be referenced.

At subsequent S20, based on expression (13), the calculation apparatus 20 calculates a number indicating a place in order, when viewed from the first major line, of the subdivided triangle specified by the value stored in idx (that is, idx_sub) among the subdivided triangles dividing the area sandwiched between the minor line pair including the subdivided triangle. That is, the above-described in-area identification number is calculated. The calculation apparatus 20 stores the calculated in-area identification number in the array tess_prim_id[idx].

$$tess\_prim \_idx = idx - csum\_prim \_num \_per \_edge [ lookup\_idx ] + prim\_num \_per \_edge [ lookup\_idx ] \qquad ( 13 )$$

At S525 and S530, the calculation apparatus 20 generates the combination information. As described above, the combination information is the information that identifies the subdivided triangle dividing the area sandwiched between the minor line pair by the in-area identification number and specifies the combination method of the minor line points belonging to the identified subdivided triangles based on the primary division point identification number and the secondary division point identification number. According to the present embodiment, as described above, the combination information specifies the combination method to form the first specifying pattern when the in-area identification number is an even number, and specifies the combination method to form the second specifying pattern when the in-area identification number is an odd number. The first specifying pattern is the pattern that specifies the combination method of the minor line points to form the triangle that projects toward the base point A_{B} side. The second specifying pattern is the pattern that specifies the combination method of the minor line points to form the triangle that projects toward the side opposite the base point A_{B}. The even number in this case includes 0.

According to the present embodiment, the combination information specifies the combination method of the minor line points belonging to the subdivided triangle based on the displacement amount of the primary division point identification number and the displacement amount of the secondary division point identification number.

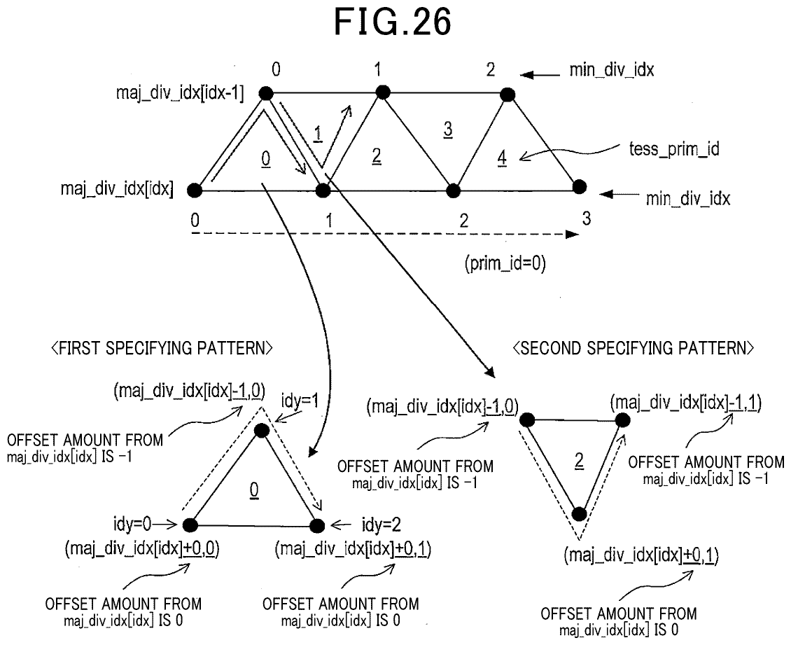

First, at S525, the displacement amount of the primary division point identification number is calculated. Here, when focus is placed only on the primary division point identification number (that is, maj_div_idx), in the first specifying pattern, as shown in FIG. 26, the combination method of the minor line points is expressed as maj_div_idx[idx]→maj_div_idx[idx−1]→maj_div_idx[idx] with the primary division point identification number of the first major line point for which the minor line pair is set as maj_div_idx[idx].

Here, with reference to maj_div_idx[idx] that is the primary division point identification number of the first major line point for which the minor line pair is set, the combination method of the minor line points is indicated by the displacement amount of the primary division point identification number such as by 0→−1→0. Meanwhile, in the second specifying pattern, with reference to maj_div_idx[idx] that is the primary division point identification number of the first major line point for which the minor line pair is set, the combination method of the minor line points is indicated by the displacement amount of the primary division point identification number such as by −1→0→−1.

Therefore, at the present step, the calculation apparatus 20 calculates the value stored in the variable maj_div_offset for the subdivided triangle specified by the value stored in idx based on expression (14). The value stored in the variable maj_div_offset indicates the displacement amount of the primary division point identification number.

$$maj\_div \_offset = \{ - mod ( tess\_prim \_id [ idx ] , 2 ) , - mod ( tess\_prim \_id [ idx ] + 1 , 2 ) , - mod ( tess\_prim \_id [ idx ] + 1 , 2 ) \} \qquad ( 14 )$$

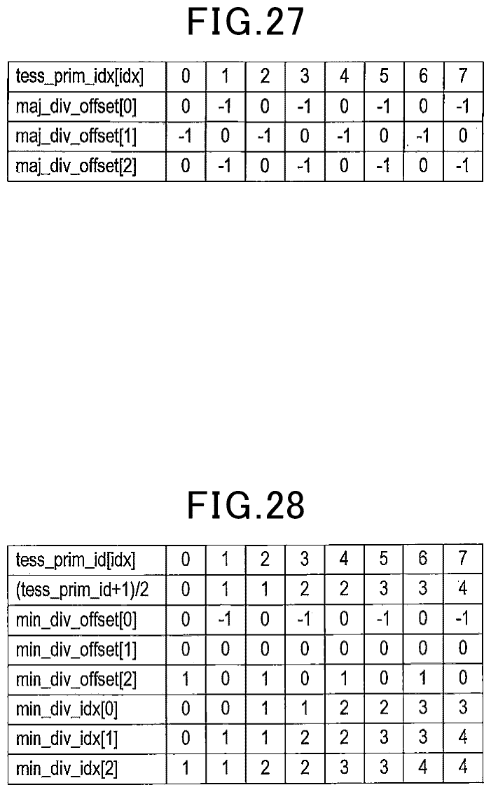

As a result, as shown in FIG. 27, when tess prim_idx[idx] is an even number, (0, −1, 0) is calculated as the displacement amount of the primary division point identification number. When tess prim_idx[idx] is an odd number, (−1, 0, −1) is calculated as the displacement amount of the primary division point identification number.

Next, at S530, the displacement amount of the secondary division point identification number is calculated. Here, focus is placed only on the secondary division point identification number (that is, maj_div_idx). In the first specifying pattern, as shown in FIG. 26, the combination method of the minor line points is expressed such as by 0→0→1 (for example, the subdivided triangle with the in-area identification number=0), 1→1→2 (for example, the subdivided triangle with the in-area identification number=2), and 2→2→3 (for example, the subdivided triangle with the in-area identification number=4).

Meanwhile, in the second specifying pattern, the combination method of the minor line points is expressed such as by 0→1→1 (for example, the subdivided triangle with the in-area identification number=1) and 1→2→2 (for example, the subdivided triangle with the in-area identification number=3).

Here, in each combination method, the secondary division identification number (also referred to hereafter as a reference secondary division identification number) of the second minor line point that is specified is referenced. In the first specifying pattern, for example, regarding the subdivided triangle having the in-area identification number=0, the combination method of the minor line points may be indicated by the displacement amount of the secondary division point identification number such as by 0→0→+1 (for example, the reference secondary division identification number=0) in relation to the reference secondary division identification number. In a similar manner, regarding the subdivided triangle having the in-area identification number=2, the combination method of the minor line points is indicated by the displacement amount of the secondary division point identification number such as by 0→0→+1 (for example, the reference secondary division identification number=1), in relation to the reference secondary division identification number. Meanwhile, in the second specifying pattern, regarding the subdivided triangle having the in-area identification number=1, the combination method of the minor line points is indicated by the displacement amount of the secondary division point identification number such as by −1→0→0 (for example, the reference secondary division identification number=1), in relation to the reference secondary division identification number. In a similar manner, regarding the subdivided triangle having the in-area identification number=3, the combination method of the minor line points is indicated by the displacement amount of the secondary division point identification number such by −1→0→0 (for example, the reference secondary division identification number=2), in relation to the reference secondary division identification number.

Therefore, at the present step, the calculation apparatus 20 calculates the value stored in the variable maj_div_offset for the subdivided triangle specified by the value stored in idx based on expression (15). The value stored in the variable maj_div_offset indicates the displacement amount of the secondary division point identification number.

$$min\_div \_offset = \{ - mod ( tess\_prim \_id [ idx ] , 2 ) , 0 , mod ( tess\_prim \_id [ idx ] + 1 , 2 ) \} \qquad ( 15 )$$

As a result, as shown in FIG. 28, when tess_prim_idx[idx] serving as the in-area identification number is an even number, (0, 0, 1) is calculated as the displacement amount of the secondary division point identification number. When tess_prim_idx[idx] is an odd number, (−1, 0, 0) is calculated as the displacement amount of the secondary division point identification number.

Next, at S535 to S560, regarding the subdivided triangle specified by the value stored in idx, the combinations of the minor line points are stored in order in the array tess_vert[idy][idx]. When the combinations of the minor line points are specified, the primary division point identification number and the secondary division point identification number are used. According to the present embodiment, the primary division point identification number and the secondary division point identification number specifying the combinations of the minor line points are determined based on the displacement amount of the primary division point identification number and the displacement mount of the secondary division point identification number described above.

First, at S535, the calculation apparatus 20 stores 0 in the variable idy.

Next, at S540, regarding the minor line point specified by the value stored in idy among the minor line points belonging to the subdivided triangle specified by the value stored in idx, the calculation apparatus 20 calculates the coordinates of both end points of the minor line including this point. The minor line point specified by the value stored in idy refers to the minor line point specified idy+1 th in the combination method based on the combination information. Both end points are the first major line point and the second major line point.

The calculation apparatus 20 stores the position vector (that is, the coordinates) of the first major line point that is one of both end points in a variable point_0 based on expression (16). In addition, the calculation apparatus 20 stores the position vector (that is, the coordinates) of the second major line point that is the other of both end points in a variable point_1 based on expression (17).

$$print\_ 0 = point\_on \_maj \_line0 [ lookup\_idx + maj\_div \_offset [ idy ] ] \qquad ( 16 )$$

$$print\_ 1 = point\_on \_maj \_line0 [ lookup\_idx + maj\_div \_offset [ idy ] ] \qquad ( 17 )$$

At subsequent S545, first, the calculation apparatus 20 calculates the secondary division identification number of the minor line point specified by the value stored in idy in the subdivided triangle specified by the value stored in idx, based on expression (18). The secondary division identification number is calculated based on the reference secondary division identification number and the displacement amount of the secondary division identification number calculated at S530. The calculation apparatus 20 stores the calculated secondary division identification number in the variable min_div_idx. floor((tess_prim_id[idx]+1)/2) in expression (18) indicates the secondary division identification number. Then, the calculation apparatus 20 calculates an internal division ratio based on expression (19) using the calculated secondary division identification number and stores the internal division ratio in a variable div_ratio.

$$min\_div \_idx = floor ( ( tess\_prim \_id [ idx ] + 1 ) / 2 ) + min\_div \_offset [ idy ] \qquad ( 18 )$$

$$div\_ratio = min\_div \_idx / min\_vert \_num [ lookup\_idx + maj\_div \_offset [ idy ] ] \qquad ( 19 )$$

The internal division ratio expresses a division ratio at which the minor line point specified by the value stored in idy among the minor line points belonging to the subdivided triangle specified by the value stored in idx divides the minor line including this point.

Next, at S550, the calculation apparatus 20 stores the calculated coordinates in the array tess_vert[idy][idx] based on expression (20).

$$tess\_vert [ idy ] [ idx ] = point\_ 0 + div\_ratio * ( point\_ 1 - point\_ 0 ) \qquad ( 20 )$$

At subsequent S555, the calculation apparatus 20 increments idy. That is, the calculation apparatus 20 stores, in idy, the value obtained by adding 1 to the value stored in idy.

Next, at S560, the calculation apparatus 20 determines whether the value stored in idy is equal to or greater than 3. Here, when determined that the value is equal to or greater than 3, the calculation apparatus 20 transitions the process to S565. Meanwhile, when determined that the value is less than 3, the calculation apparatus 20 repeats the processes at S540 to S560 until idy becomes equal to or greater than 3.

At S565, the calculation apparatus 20 increments idx. That is, the calculation apparatus 20 stores, in idx, a value obtained by adding 1 to the value stored in idx.

At S570, the calculation apparatus 20 determines whether the value stored in idx is equal to or greater than R. Here, when determined that the value is less than R, the calculation apparatus 20 transitions the process to S515 and repeats the processes at S515 to S570. Meanwhile, when determined that the value is equal to or greater than R, the calculation apparatus 20 thereby ends the present subdivision process.

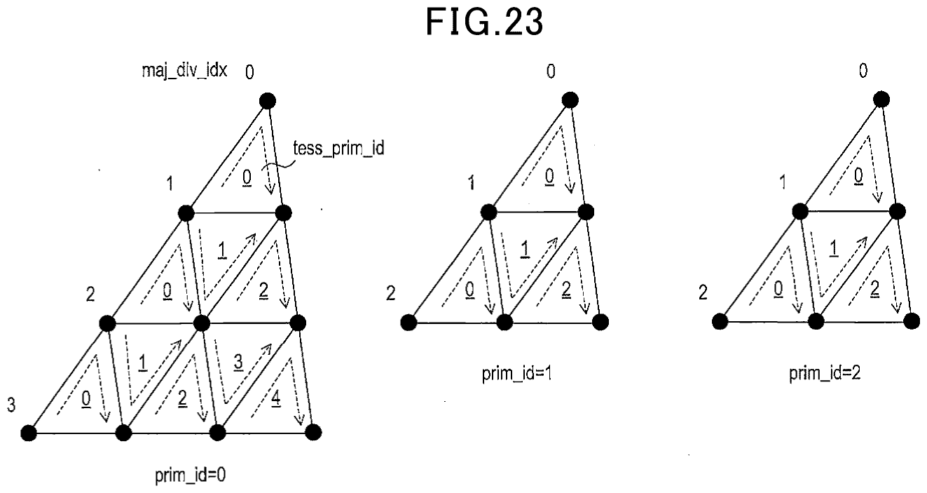

Workings of the subdivision process will be described with reference to FIG. 20 to FIG. 23, FIG. 25, and FIG. 29.

When the loop number is the cumulative sum R as described above, the elements maj_line_lookup_idx[0] to maj_line_lookup_idx[R−1] of the array are stored as a result of S515 being repeated. For example, as shown in FIG. 22, the minor line points may be arranged with Q=10. As shown in FIG. 29, as the elements maj_line_lookup_idx[0] to maj_line_lookup_idx[Q−1] of the array, 1, 2, 2, 2, 3, 3, 3, 3, 3, 5, . . . are respectively stored. That is, an index (that is, idx_m) when the major line parameter array is referenced is set for each subdivided triangle specified by the value stored in idx.

Hereafter, of the examples shown in FIG. 20 to FIG. 23, the workings in the case in which idx=9 (that is, idx_sub=9) will be described. As shown in FIG. 22, the subdivided triangle specified by idx=9 includes the basic triangle specified by prim_id=1.

At S515, regarding the subdivided triangle specified by idx=9, maj_line_lookup_idx[9]=5 is set as lookup_idx. As a result, as indicated by an arrow in FIG. 29, for example, the major line parameter array can be referenced. For example, the primary division point identification number (maj_div_idx) of the first major line point to which the minor line pair including the subdivided triangle specified by idx=9 may be set is identified as 1. That is, max_div_idx[lookup_idx]=1 (for example, lookup_idx=5).

At S520, regarding the subdivided triangle specified by idx=9, the in-area identification number (that is, tess_prim_id[9]) is calculated as 9−10+1=0 based on expression (13).

At S525, maj_div_offset is calculated as (0, −1, 0) based on expression (14), and at

S530, maj_div_offset is calculated as (0, 0, 1) based on expression (15).

At S535 to S560, when idy=0, both end points of the reference minor line (that is, the minor line set for the first major line point that is maj_div_idx=1) of the minor line pair are identified at S540. At S545, the secondary division identification number is calculated as 0 based on expression (18), and the internal division ratio is calculated as 0. At S550, based on the internal division ratio, the coordinates of the first major line point that is either of both end points of the reference minor line is identified as the first minor line point belonging to the subdivided triangle.

In a similar manner, when idy=1, both end points (that is, the base point A_{B} in this example) of the adjacent minor line (that is, the minor line set for the first major line point that is maj_div_idx=0) of the minor line pair is identified at S540. At S545, the secondary division identification number is calculated as 0 based on expression (18) and the internal division ratio is calculated as 0. At S550, based on the internal division ratio, the coordinates (that is, the base point A_{B} in this example) of the first major line point that is either of both end points of the adjacent minor line is identified as the second minor line point belonging to the subdivided triangle.

In a similar manner, when idy=2, both end points of the reference minor line (that is, the minor line set for the first major line point that is maj_div_idx=1) of the minor line pair is identified at S540. At S545, the secondary division identification number is calculated as 1 based on expression (18) and the internal division ratio is calculated as 1/1=1. At S550, based on the internal division ratio, the coordinates of the second major line point that is the other of both end points of the reference minor line is identified as the third minor line point belonging to the subdivided triangle.

In this manner, regarding the subdivided triangle specified by idx=9, the combination method of the minor line points belonging to the subdivided triangle is identified (that is, the first specifying pattern). Then, the position vectors (that is, the coordinates) identified in order based on the combination method are stored in the array tess_vert[idy][idx].

The calculation apparatus 20 performs a similar process for the subdivided triangles specified by idx=0 to R−1. As a result, the array tess_vert[idy][idx] including the vertex coordinates of a total of an R number of subdivided triangles is obtained.

In this manner, based on simple rules using the displacement amount that serves as the combination information, the subdivided triangles that divide the area sandwiched between the minor line pair without overlapping one another and connect minor line points that are adjacent to each other are generated.

### [1-3. Effects]

The following effects are achieved according to the first embodiment described in detail above.

(1a) At S2, the calculation apparatus 20 performs pre-shaping (that is, S11). In pre-shaping, at S120, the calculation apparatus 20 determines whether each basic triangle defined by the polygon vertex coordinate data (that is, the array vertices[]) is the target triangle. At S150, the calculation apparatus 20 shapes the basic triangle determined to not be the target triangle (that is, the basic triangle determined to be the non-target triangle) to have a shape having a relatively high degree of similarity to an equilateral triangle. That is, the basic triangle determined to not be the target triangle is divided into a plurality of triangles to have a shape having a relatively high degree of similarity to an equilateral triangle.

At S155, the calculation apparatus 20 generates the new array vertices[] including the vertex coordinates of the triangles after division. At S2, in multi-stage division (that is, S12) following pre-shaping, the calculation apparatus 20 calculates the coordinates of the vertices of the plurality of subdivided triangles dividing an area of the basic triangle into parts smaller than the basic triangle for each basic triangle defined by the coordinates of the vertices including the new vertex coordinate group generated at S155.

In the calculation apparatus 20 such as this, the basic triangle defined by the coordinates of the vertices included in the new array vertices[] generated at S155 has a shape having a relatively high degree of similarity to an equilateral triangle as a result of S150 being performed. The calculation apparatus 20 calculates the coordinates of the vertices of the plurality of subdivided triangles for each of the basic triangles such as this. Therefore, compared to a case in which the basic triangle is divided into the subdivided triangles without S150 being performed, the subdivided triangles having a relatively high degree of similarity to an equilateral triangle can be obtained. As a result, the new subdivided triangles generated by the basic triangle being divided can be suppressed from becoming less like an equilateral triangle.

(1b) Specifically, the calculation apparatus 20 determines whether the maximum value of the interior angle is less than the allowable angle for each basic triangle, and determines that the basic triangle is the target triangle when the maximum value of the interior angle is less than the allowable angle. In addition, when the maximum value of the interior angle is equal to or greater than the allowable angle, the calculation apparatus 20 determines that the basic triangle is not the target triangle (that is, is the non-target triangle). The calculation apparatus 20 can simply determine whether the basic triangle is the target triangle by a mathematical expression using the maximum value of the interior angle.

(1c) When determined that the basic triangle is not the target triangle, the calculation apparatus 20 divides the basic triangle into two by a bisector that bisects the interior angle having the maximum value in the basic triangle. As a result, for example, when the triangle before division is a shape relatively dissimilar to the equilateral triangle, such as the maximum interior angle being equal to or greater than 120°, the triangle is divided into two such that the maximum interior angle is bisected. Compared to a case in which an arbitrary interior angle (such as the smallest interior angle) is repeatedly bisected and the triangle is divided, the calculation apparatus 20 can give the triangle after division a shape having a relatively high degree of similarity to an equilateral triangle.

(1d) For example, the allowable angle is 120°. As a result, the calculation apparatus 20 can set the largest interior angle of the triangle after division to 60°≤largest interior angle<90° and can bring the triangle after division closer to the shape having a relatively high degree of similarity to an equilateral triangle.

(1e) At S2, the calculation apparatus 20 performs multi-stage division (that is, S12).

In multi-stage division, at S21, the calculation apparatus 20 sets the primary division number that serves as the division number when the first major line is equally divided into a plurality of parts. The first major line is equally divided based on the division length d₀. At S22, the calculation apparatus 20 sets the secondary division number when the minor line is equally divided, the minor line being set for each of the plurality of first major line points set on the first major line. The minor line is equally divided based on the same division length d₀ as that for dividing the first major line points.

At S23, the calculation apparatus 20 calculates the coordinates of the vertices of the subdivided triangle for each minor line pair set for each first major line using the array vertices[], maj_vert_num, and the combination information. The combination information is information specifying the combination method of the minor line points belonging to each subdivide triangle for each minor line pair that is set for each major line point. The subdivided triangle refers to one or more triangles that divide an area of the basic triangle sandwiched between the minor line pair without overlapping each other with the minor line points on two minor lines belonging to the minor line pair as vertices, for each minor line pair.

The calculation apparatus 20 such as this can set a spacing of the first major line points and a spacing of the minor line points to be substantially similar through division based on the division length d₀. That is, of the three sides of the subdivided triangle, sides that run along two sides can be set to substantially the same length. The two sides are the side along the first major line on which the first major line points are set and the minor line on which the minor line points are set. Therefore, the basic triangle can be divided into the subdivided triangles that have a shape having a relatively high degree of similarity to an equilateral triangle. As a result, the new subdivided triangle generated by the basic triangle being divided can be suppressed from becoming unlike an equilateral triangle. Here, according to the present embodiment, when the basic triangle has a shape having a relatively high degree of similarity to an equilateral triangle, a greater effect can be achieved.

(1f) The calculation apparatus 20 sets, in the basic triangle, the opposing side of the interior angle having the largest angle as the first major line, the opposing side of the interior angle having the angle that is second largest to the largest angle as the second major line, and the opposing side of the interior angle having the smallest angle as the third major line. That is, the second major line has a length that is relatively closer to that of the first major line than the third major line. As a result of the second major line being divided at a same division ratio as the first major line, the spacing of the second major line points can be brought relatively closer to the spacing (that is, the division length d₀) of the first major line points.

The calculation apparatus 20 such as this can set the side that runs along the second major line on which the second major line points are set, among the three sides of the subdivided triangle, to be relatively close to the division length d₀. As a result, the subdivided triangle can be made to have a shape having a relatively high degree of similarity to an equilateral triangle.

(1g) The combination information specifies the minor line points in the following manner for each minor line pair set for the first major line point when the minor line points belonging to a subdivided triangle are specified. The combination information alternately specifies the minor line point (that is, the reference minor line point) on the minor line set for each first major line point and the minor line point (that is, the adjacent minor line point) on the minor line adjacent thereto in order along the minor line.

In order along the minor line means in order of array of the minor line points on the minor line. Alternately refers to the adjacent minor line point being subsequently specified after the reference minor line point is specified, and the reference minor line point being subsequently specified after the adjacent minor line point is specified.

The calculation apparatus 20 can specify the minor line point belonging to the subdivided triangle including two sides corresponding to the division length d₀ by specifying the minor line point belonging to the triangle by alternately moving between two minor lines in the minor line pair. The two sides corresponding to the division length d₀ are the side parallel to the first major line and the side included on the minor line in the subdivided triangle dividing the area sandwiched between the minor lines. As a result, the basic triangle can be divided into a plurality of subdivided triangles that have a shape having a relatively high degree of similarity to an equilateral triangle.

(1) In addition, in above-described (1g), specifically, the combination information may include at least either of the first specifying pattern and the second specifying pattern when the minor line points belonging to the subdivided triangle are specified. The first specifying pattern specifies the minor line points belonging to the subdivided triangle in order from the reference minor line point to the adjacent minor line point to the other reference minor line point that is adjacent thereto. That is, the minor line points closest to one another belonging to a triangle are specified. The second specifying pattern specifies the minor line point belonging to the subdivided triangle in order from the adjacent minor line point to the reference minor line point to the other adjacent minor line point adjacent thereto. That is, in a manner similar to the first specifying pattern, the minor line points that are closest to one another are specified.

The calculation apparatus 20 can obtain a shape having a relatively high degree of similarity to an equilateral triangle for the subdivided triangle that projects towards the base point A_{B} side in the first specifying pattern and for the subdivided triangle that projects towards the side opposite the base point A_{B} in the second specifying pattern.

(2) In (1) of (1g) described above, the combination information may alternately specify the first specifying pattern and the second specifying pattern when a plurality of subdivided triangles dividing the area sandwiched between the minor line pair is present. The calculation apparatus 20 can divide the area of the basic triangle sandwiched between the minor line pairs without overlapping each other by repeating the division into the subdivided triangles by the first specifying pattern and the second specifying pattern.

(1h) In any one of (1g), and (1) and (2) of (1g) described above, the calculation apparatus 20 sets the primary division point identification number (that is, maj_div_idx) for the first major line point at S330. The calculation apparatus 20 sets the secondary division point identification number (that is, maj_div_idx) for the minor line point at S545. For example, the secondary division point identification number may be set in order from the first major line side. Each of the minor line points is identified by the primary division point identification number and the secondary division point identification number. The combination information specifies the combination method of the minor line points belonging to the subdivided triangle dividing the area of the basic triangle sandwiched between the minor line pairs based on the primary division point identification number and the secondary division point identification number.

The calculation apparatus 20 can uniformly identify the combination method of the minor line points belonging the subdivided triangle using the combination information. (1) In (1h) described above, in the calculation apparatus 20, the combination information may specify the combination method of the minor line points belonging to the subdivided triangle based on the displacement amount of the primary division point identification number and the displacement amount of the secondary division point identification number.

Because the combination number can be simple information having regularity based on the displacement amount, an information amount of the combination information can be reduced. As a result, generation when the calculation apparatus 20 generates the combination information is facilitated, and memory capacity when the calculation apparatus 20 stores the combination information in advance can be reduced.

(2) In (1) of (1h) described above, in the calculation apparatus 20, the displacement amount of the primary division point identification number may be expressed as a displacement amount in relation to the primary division point identification number of the minor line point on the minor line set for the first major line point. The displacement amount of the secondary division identification number may be expressed as a displacement amount in relation to the secondary division point identification number of the minor line point specified second when the minor line points belonging to the subdivided triangle are specified. The calculation apparatus 20 can generate the subdivided triangles that are in the above-described first specifying pattern and second specifying pattern by a similar method for each first major line point using the combination information based on the displacement amount. Here, when the calculation apparatus 20 is capable of parallel processing, similar parallel processing can be performed for each first major line point.

(3) The calculation apparatus 20 can generate the combination information as described above. Because a table indicating the combination information is no longer required to be stored in a storage apparatus or the like in advance, memory capacity of the calculation apparatus 20 can be suppressed.

### <Correspondence Between Terms>

The calculation apparatus 20 corresponds to a triangle generation apparatus. The array vertices[] corresponds to a vertex coordinate group. The value of the first term in expression (2) corresponds to the primary division number and the value of the first term in expression (10) corresponds to the secondary division number. The first major line corresponds to the first side. The second major line corresponds to the second side. The third major line corresponds to the third side. The first major line point corresponds to the primary division point and the minor line point corresponds to the secondary division point. maj_div_idx corresponds to the primary division point identification number and min_div_idx corresponds to the secondary division point identification number. maj_div_offset corresponds to the displacement amount of the primary division point identification number and min_div_offset corresponds to the displacement amount of the secondary division point identification number.

S1 corresponds to a process as an acquisition unit. S2 corresponds to a process as a triangle division unit. S11 corresponds to a process as a pre-shaping unit. S120 corresponds to a process as a target determining unit. S150 corresponds to a process as a pre-shaping execution unit. S155 corresponds to a process as an addition unit. S21 and S240 correspond to a process as a primary division number setting unit. S22 and S350 correspond to a process as a secondary division number setting unit. S23 corresponds to a process as an execution unit. S33 corresponds to a process as a primary identification setting unit. S545 corresponds to a process as a secondary identification setting unit.

### [2. Second Embodiment]

### [2-1. Configuration]

A second embodiment of the present disclosure will be described below with reference to the drawings. Here, sections according to the second embodiment differing from those according to the first embodiment will be described. Common configurations are given the same reference numbers.

The calculation apparatus 20 according to the second embodiment differs from that according to the first embodiment in that a GPU 22 is included and various types of processes are performed in parallel using the GPU 22. For example, the GPU 22 serving as the calculation apparatus 20 may perform pre-shaping at S11 and multi-stage division at S12. For example, the GPU 22 may perform the processes repeatedly performed for each basic triangle specified by the value stored in idx in parallel by parallel processing in pre-shaping performed at S11.

Specifically, S105 to S130 shown in FIG. 4 are processes repeated for each idx. Therefore, the GPU 22 may provide a thread for each idx at S105 to S130 and perform the processes at S105 to S120 in parallel in each thread. In addition, because S140 to S165 are processes repeated for each idx, the GPU 22 may provide a thread for each idx at S140 to S165 and perform the processes at S140 to S155 in parallel in each thread. Furthermore, because S170 to S185 are processes repeated for each idx, the GPU 22 may provide a thread for each idx at S170 to S185 and perform the processes at S170 to S175 in parallel in each thread.

In addition, for example, in multi-stage division performed at S12, the GPU 22 may perform the processes repeatedly performed for each basic triangle specified by the value stored in idx or the processes repeatedly performed for each first major line point specified by the value stored in idx in parallel by parallel processing.

Specifically, because S200 to S260 shown in FIG. 15 are processes repeated for each idx, the GPU 22 may provide a thread for each idx at S200 to S260 and perform the processes at S200 to S240 in parallel for each thread. In addition, because S300 to S380 shown in FIG. 16 are processes repeated for each idx, the GPU 22 may provide a thread for each idx at S300 to S380 and perform the processes at S300 to S360 in parallel for each thread. Furthermore, because S500 to S570 shown in FIG. 18 are processes repeated for each idx, the GPU 22 may provide a thread for each idx at S500 to S570 and perform the processes at S500 to S560 in parallel for each thread.

### [2-2. Effects]

(2a)

The calculation apparatus 20 such as this determines whether the basic triangle is the target triangle by rearranging the vertex coordinates in descending order in parallel for each basic triangle. Therefore, processing speed of pre-shaping and, further, triangle divisin can be improved.

In addition, the calculation apparatus 20 such as this sets the first major line points in parallel for each basic triangle in multi-stage division. Therefore, processing speed of multi-stage division and triangle division can be improved. Furthermore, the calculation apparatus 20 such as this calculates the coordinates of the vertices of the subdivided triangle in parallel for each first major line. Therefore, processing speed of multi-stage division and triangle division can be improved.

According to the second embodiment, the GPU 22 corresponds to the triangle processing apparatus. Here, instead of the GPU 22, the CPU 21 capable of performing parallel processing may perform the above-described parallel processing. In this case, the CPU 21 capable of performing parallel processing corresponds to the triangle generation apparatus.

### [2. Third Embodiment]

### [3-1. Configuration]

A third embodiment of the present disclosure will be described below with reference to the drawings. Here, sections according to the third embodiment differing from those according to the second embodiment will be described. Common configurations are given the same reference numbers.

According to the above-described second embodiment, for example, an aspect in which parallel processing by the GPU 22 may not be performed in the processes for calculating the cumulative sum such as S135, S270, and S390 is described. However, for example, the GPU 22 may perform parallel processing in the processes for calculating the cumulative sum as well by performing cumulative sum parallel processing described hereafter.

### [3-2. Processes]

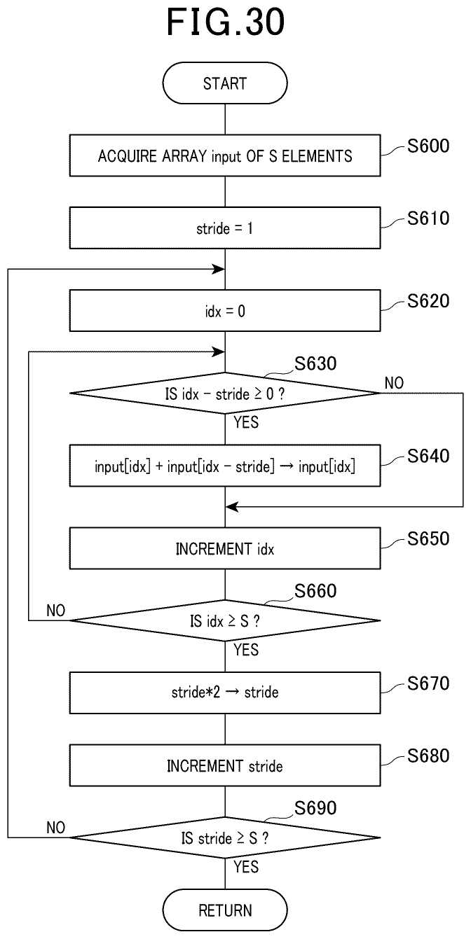

The cumulative sum parallel processing will be described with reference to a flowchart in FIG. 30.

### <Description of Arrays>

In the present process, an array input[idx] is the input array. The array input[idx] is an array that stores values for which the cumulative sum is to be calculated.

When the cumulative sum parallel processing is ended, the cumulative sum of the array input[idx] is stored in the array input[idx]. For example, regarding array input[0] to input[S−1], in a case in which an S number of cumulative sums are calculated, when the cumulative sum parallel processing is ended, the element input[0] of the array specified by idx=0 may be stored in the array input[0]. A sum of the element input[0] of the array specified by idx=0 and the element input[1] of the array specified by idx=1 is stored in the array input[1]. In addition, a total sum of each of the element input[0] of the array to the element input[S−1] of the array is stored in the array input[S−1].

### <Processes>

First, at S600, the GPU 22 acquires the array input[idx] of which the number of elements is S. The range of idx is 0≤idx≤S−1.

Next, at S610, the GPU 22 stores 1 in a variable stride.

At subsequent S620, the GPU 22 stores 0 in idx.

Next, at S630, the GPU 22 determines whether idx-stride≥0. Here, when idx-stride<0, the GPU 22 transitions the process to S650. Meanwhile, when idx-stride≥0, the GPU 22 transitions the process to S640.

At S640, the sum of the element input[idx] of the array and the element input[idx-stride] of the array is stored as the new element input[idx] of the array.

At S650, the GPU 22 increments idx. That is, the GPU 22 stores, in idx, a value obtained by adding 1 to the value stored in idx.

At S670, the GPU 22 determines whether the value stored in idx is equal to or greater than S. Here, when determined that the value is equal to or greater than S, the GPU 22 transitions the process to S670. Meanwhile, when determined that the value is less than S, the GPU 22 transitions the process to S630 and repeats the processes at S630 to S660.

At S670, stride*2 is stored as a new value of stride.

At S680, stride is incremented. That is, the GPU 22 stores, in stride, a value obtained by adding 1 to the value stored in stride i.

At S690, the GPU 22 determines whether the value stored in stride is equal to or greater than S. Here, when determined that the value is less than S, the GPU 22 transitions the process to S620 and repeats the processes at S620 to S690. Meanwhile, when determined that the value is equal to or greater than S, the calculation apparatus 20 thereby ends the present cumulative sum parallel processing.

### <Workings>

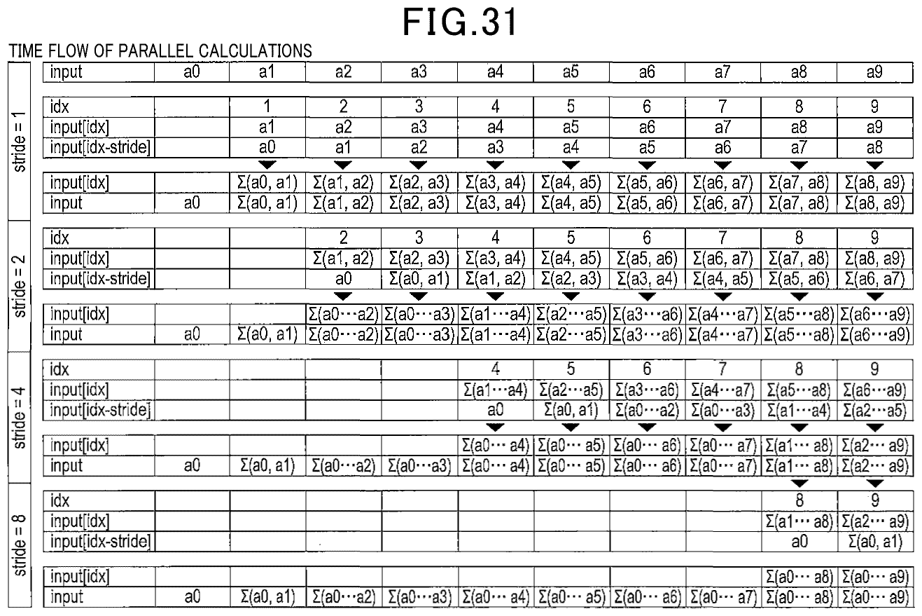

As a result of the cumulative sum parallel processing being performed, as shown in FIG. 31, in the array input[S−1], the total sum of the element input[0] of the array to the element input[S−1] of the array is stored.

For example, at S135, the above-described array input[] may be replaced with array flag[]. As a result of the above-described cumulative sum parallel processing being performed, the total sum (that is, the cumulative sum) of the element flag[idx] of the array is stored in the element flag[L−1] of the array.

In addition, for example, at S270, the above-described array input[] may be replaced with array maj_vert_num[]. As a result of the above-described cumulative sum parallel processing being performed, the cumulative sum Q is stored in the element maj_vert_num[P−1] of the array.

Furthermore, for example, at S390, the above-described array input[] may be replaced with array prim_num_per_edge[]. As a result of the above-described cumulative sum parallel processing being performed, the cumulative sum R is stored in the element maj_vert_num[Q−1] of the array.

### [3-3. Effects]

In this manner, as a result of the calculation apparatus 20 performing parallel processing for each idx in cumulative sum as well, the processing speed can be further improved. In addition, the calculation apparatus 20 can set a thread for each first major line point and perform the triangle division in parallel for each first major line point. Therefore, processing speed can be further improved.

According to the third embodiment, the GPU 22 corresponds to the triangle processing apparatus. Here, instead of the GPU 22, the CPU 21 capable of performing parallel processing may perform the above-described parallel processing. In this case, the CPU 21 capable of performing parallel processing corresponds to the triangle generation apparatus.

### [4. Other Embodiments]

Embodiments of the present disclosure are described above. However, the present disclosure is not limited to the above-described embodiments and can be modified in various ways.

(4a) According to the above-described embodiments, an aspect is described in which, when the largest interior angle of the basic triangle is less than a predetermined angle (such as) 120°, the basic triangle is determined to be the target triangle. However, the basic triangle may be determined to be the target triangle when, in the basic triangle, a ratio of the length of remaining sides to the length of one side is within a predetermined range. For example, h1≤ratio of length≤h2 (such as h1<1 and h2>1). The possible range of the ratio of length is not limited thereto and may be arbitrarily set.

(4b) According to the above-described embodiments, an aspect is described in which the calculation apparatus 20 generates the combination information and generates the subdivided triangles based on the generated combination information (that is, by acquiring the generated combination information). However, the calculation apparatus 20 may store the combination information as a table in the memory in advance and generate the subdivided triangles based on the combination information stored in the memory. As a result, processing load on the calculation apparatus 20 can be reduced.

(4c) According to the above-described embodiments, an aspect is described in which the primary division point identification number is set in order from the base point A_{B} that is a vertex of the basic triangle and connects the first major line and the second major line.

However, the primary division point identification number may be set with either of both end points of the first major line being 0. For example, the primary division point identification numbers may be set to 0, 1, 2, . . . in order from the right vertex A_{R} toward the base point AB, the right vertex A_{R} being a vertex of the basic triangle and an intersection between the first major line and the second major line. In this case, in the minor line pair, the primary division point identification number of the reference minor line point+1 is the primary division point identification number of the adjacent minor line point. In this case, for example, when tess_prim_idx[idx] is an even number, (0,+1, 0) may be calculated as the displacement amount of the primary division point identification number. In addition, for example, when tess_prim_idx[idx] is an odd number, (+1, 0,+1) may be calculated as the displacement amount of the primary division point identification number.

(4d) According to the above-described embodiments, an aspect is described in which the secondary division point identification number is set in order from the first major line side in the basic triangle. However, the secondary division point identification number may be set with either of both end points of the minor line being 0. For example, the secondary division point identification numbers may be set to 0, 1, 2, . . . in order towards the first major line with the second major line side as a starting point. In this case, as the displacement amount of the secondary division point identification number, the displacement amount similar to that according to the above-described embodiments may be used.

(4e) According to the above-described embodiments, an aspect in which the calculation apparatus 20 performs both pre-shaping and multi-stage division in the triangle division process is described. However, the calculation apparatus 20 may perform only multi-stage division in the triangle division process.

(4f) According to the above-described embodiment, an aspect is described in which, in the basic triangle, the first major line is the opposing side of the interior angle having the largest interior angle, the second major line is the opposing side of the interior angle having the second largest angle to the largest angle, and the third major line is the opposing side of the interior angle having the smallest angle. However, for example, the first major line may be the opposing side of the interior angle having the second largest angle to the largest angle, the second major line may be the opposing side of the interior angle having the largest angle, and the third major line may be the opposing side of the interior angle having the smallest angle.

(4g) The calculation apparatus 20 and the method thereof described in the present disclosure may be actualized by a dedicated computer that is provided such as to be configured by a processor and a memory, the processor being programmed to provide one or a plurality of functions that are realized by a computer program. Alternatively, the calculation apparatus 20 and the method thereof described in the present disclosure may be actualized by a dedicated computer that is provided by a processor being configured by a single dedicated hardware logic circuit or more. Still alternatively, the calculation apparatus 20 and the method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible storage medium that can be read by a computer as instructions performed by the computer. The method actualizing the functions of sections included in the calculation apparatus 20 is not necessarily required to include software. All functions thereof may be actualized using one or a plurality of pieces of hardware.

(4h) A plurality of functions provided by a single constituent element according to the above-described embodiments may be actualized by a plurality of constituent elements. A single function provided by a single constituent element may be actualized by a plurality of constituent elements. In addition, a plurality of functions provided by a plurality of constituent elements may be actualized by a single constituent element. A single function provided by a plurality of constituent elements may be actualized by a single constituent element. Furthermore, a part of a configuration according to the above-described embodiment may be omitted. Moreover, at least a part of a configuration according to an above-described embodiment may be added to or replace a configuration according to another of the above-described embodiments.

(4i) The present disclosure can also be actualized by various modes in addition to the above-described calculation apparatus 20, such as an apparatus or a system in which the calculation apparatus 20 is a constituent element, a program for enabling a computer to function as the calculation apparatus 20, a non-transitory, tangible storage medium such as a semiconductor memory that records the program therein, and a triangle generation method. The apparatus in which the calculation apparatus 20 is a constituent element may include, for example, a radar simulator.

### [Technical Ideas Disclosed in the Present Description]

### [Item 1]

A triangle generation apparatus including: an acquisition unit (S1) that is configured to acquire a vertex coordinate group including coordinates of each vertex of one or a plurality of basic triangles; and a triangle division unit (S2) that is configured to divide each basic triangle defined by the coordinates of the vertices included in the vertex coordinate group into a plurality of subdivided triangles, in which the triangle division unit includes a target determining unit (S120) that is configured to determine whether each basic triangle defined by the vertex coordinate group is a target triangle that has a shape having a relatively high degree of similarity to an equilateral triangle, a pre-shaping execution unit (S150) that is configured to divide the basic triangle determined to not be the target triangle into a plurality of triangles to have the shape having a relatively high degree of similarity to an equilateral triangle, and an addition unit (S155) that is configured to generate the new vertex coordinate group including the vertex coordinates of the triangles after division, and for each basic triangle defined by the coordinates of the vertices included in the new vertex coordinate group generated by the addition unit, the triangle division unit calculates the coordinates of the vertices of a plurality of subdivided triangles dividing an area of the basic triangle into parts smaller than the basic triangle.

### [Item 2]

The triangle generation apparatus according to item 1, in which: the target determining unit determines whether a maximum value of an interior angle is less than an allowable angle for each basic triangle, and determines that the basic triangle is the target triangle when the maximum value of the interior angle is less than the allowable angle and determines that the basic triangle is not the target triangle when the maximum value of the interior angle is equal to or greater than the allowable angle.

### [Item 3]

The triangle generation apparatus according to item 1 or 2, in which: the pre-shaping execution unit divides the basic triangle into two by a bisector that bisects an interior angle having a maximum value in the basic triangle when the target determining unit determines that the basic triangle is not the target triangle.

### [Item 4]

The triangle generation apparatus according to any one of items 1 to 3, in which: the triangle division unit further includes a primary division number setting unit (S21, S240) that is configured to set a primary division number (M) when a first side of the basic triangle is equally divided based on a division length prescribed in advance, a secondary division number setting unit (S22, S350) that is configured to set a secondary division number (N) when a minor line is equally divided based on the division length, the minor line being set for each of a plurality of primary division points set on the first side, and an execution unit (S23) that is configured to acquire combination information, the combination information being information specifying a combination method of secondary division points belonging to the subdivided triangle for each minor line pair set for each primary division point, the subdivided triangle being one or more triangles dividing an area of the basic triangle sandwiched between the minor line pair without overlapping each other and with the secondary division points on the two minor lines belonging to the minor line pair as vertices, and calculate the coordinates of the vertices of the subdivided triangle for each minor line pair set for each primary division point using the vertex coordinate group, the primary division number, and the combination information, and the primary division points are a plurality (M+1) of points including both end points of the first side and in positions equally dividing the first side by the primary division number, the minor line is a line segment that passes through the primary division point and runs from the first side to a second side along a third side, the secondary division points are a plurality (N+1) of points including both end points of the minor line and equally dividing the minor line by the secondary division number, and the minor line pair is a combination of two arbitrary adjacent minor lines among the minor lines, and the triangle division unit sets the primary division number by the primary division number setting unit and the secondary division number by the secondary division number setting unit for each basic triangle defined by the coordinates of the vertices included in the new vertex coordinate group generated by the addition unit and calculates, by the execution unit, the coordinates of the vertices of the plurality of subdivided triangles that divide the area of the basic triangle into parts smaller than the basic triangle.

### [Item 5]

The triangle generation apparatus according to item 4, in which: in the basic triangle, the first side is an opposing side of an interior angle having a largest angle, the second side is an opposing side of an interior angle having a second largest angle to the largest angle, and the third side is an opposing side of an interior angle having a smallest angle.

### [Item 6]

The triangle generation apparatus according to item 4 or 5, in which: the combination information alternately specifies a secondary division point on a minor line set for each primary division point and a secondary division point on an adjacent minor line, for each minor line pair set for each primary division point when specifying the secondary division points belonging to a single subdivided triangle.

### [Item 7]

The triangle generation apparatus according to any one of items 4 to 6, further including: a primary division point identification setting unit (S330) that is configured to set a primary division point identification number identifying each primary division point for each primary division point; and
a secondary division point identification setting unit (S545) that is configured to set a secondary division point identification number identifying each secondary division point for each secondary division point, in which each secondary division point is identified by the primary division point identification number and the secondary division point identification number, and the combination information specifies the combination method of the secondary division points belonging to the subdivided triangles based on the primary division point identification number and the secondary division point identification number.

### [Item 8]

The triangle generation apparatus according to any one of items 4 to 7, in which: the execution unit calculates the coordinates of the vertices of the subdivided triangles in parallel for each primary division point.

### [Item 9]

A triangle generation method that is configured to acquire a vertex coordinate group including coordinates of each vertex of one or a plurality of basic triangles and divide each basic triangle defined by the coordinates of the vertices included in the vertex coordinate group into a plurality of subdivided triangles, the triangle generation method including: determining whether each basic triangle defined by the vertex coordinate group is a target triangle that has a shape having a relatively high degree of similarity to an equilateral triangle (S120); dividing the basic triangle determined to not be the target triangle into a plurality of triangles to have the shape having a relatively high degree of similarity to an equilateral triangle (S150); generating the new vertex coordinate group including the vertex coordinates of the triangles after division (S155); and for each basic triangle defined by the coordinates of the vertices included in the new vertex coordinate group, calculating the coordinates of the vertices of a plurality of subdivided triangles dividing an area of the basic triangle into parts smaller than the basic triangle.

### [Item 10]

A non-transitory computer-readable storage medium storing a triangle generation program that causes a computer to function as a triangle generation apparatus, the triangle generation program including: an acquiring step (S1) that is configured to acquire a vertex coordinate group including coordinates of each vertex of one or a plurality of basic triangles; and a triangle dividing step (S2, S12) that is configured to divide each basic triangle defined by the coordinates of the vertices included in the vertex coordinate group into a plurality of subdivided triangles, in which the triangle dividing step includes a target determining step (S120) that is configured to determine whether each basic triangle defined by the vertex coordinate group is a target triangle that has a shape having a relatively high degree of similarity to an equilateral triangle, a pre-shaping executing step (S150) that is configured to 5 divide the basic triangle determined to not be the target triangle into a plurality of triangles to have the shape having a relatively high degree of similarity to an equilateral triangle, and an adding step (S155) that is configured to generate the new vertex coordinate group including the vertex coordinates of the triangles after division, and for each basic triangle defined by the coordinates of the vertices included in the new vertex coordinate group generated at the adding step, the coordinates of the vertices of a plurality of subdivided triangles dividing an area of the basic triangle into parts smaller than the basic triangle are calculated.

What is claimed is:

1. A triangle generation apparatus comprising:
an acquisition unit that is configured to acquire a vertex coordinate group including coordinates of each vertex of one or a plurality of basic triangles; and
a triangle division unit that is configured to divide each basic triangle defined by the coordinates of the vertices included in the vertex coordinate group into a plurality of subdivided triangles, wherein
the triangle division unit includes
a target determining unit that is configured to determine whether each basic triangle defined by the vertex coordinate group is a target triangle that has a shape having a relatively high degree of similarity to an equilateral triangle,
a pre-shaping execution unit that is configured to divide the basic triangle determined to not be the target triangle into a plurality of triangles to have the shape having a relatively high degree of similarity to an equilateral triangle, and
an addition unit that is configured to generate the new vertex coordinate group including the vertex coordinates of the triangles after division, and
for each basic triangle defined by the coordinates of the vertices included in the new vertex coordinate group generated by the addition unit, the triangle division unit calculates the coordinates of the vertices of a plurality of subdivided triangles dividing an area of the basic triangle into parts smaller than the basic triangle.

2. The triangle generation apparatus according to claim 1, wherein:
the target determining unit determines whether a maximum value of an interior angle is less than an allowable angle for each basic triangle, and determines that the basic triangle is the target triangle when the maximum value of the interior angle is less than the allowable angle and determines that the basic triangle is not the target triangle when the maximum value of the interior angle is equal to or greater than the allowable angle.

3. The triangle generation apparatus according to claim 1, wherein:
the pre-shaping execution unit divides the basic triangle into two by a bisector that bisects an interior angle having a maximum value in the basic triangle when the target determining unit determines that the basic triangle is not the target triangle.

4. The triangle generation apparatus according to claim 1, wherein:
the triangle division unit further includes
a primary division number setting unit that is configured to set a primary division number when a first side of the basic triangle is equally divided based on a division length prescribed in advance,
a secondary division number setting unit that is configured to set a secondary division number when a minor line is equally divided based on the division length, the minor line being set for each of a plurality of primary division points set on the first side, and
an execution unit that is configured to acquire combination information, the combination information being information specifying a combination method of secondary division points belonging to the subdivided triangle for each minor line pair set for each primary division point, the subdivided triangle being one or more triangles dividing an area of the basic triangle sandwiched between the minor line pair without overlapping each other and with the secondary division points on the two minor lines belonging to the minor line pair as vertices, and calculate the coordinates of the vertices of the subdivided triangle for each minor line pair set for each primary division point using the vertex coordinate group, the primary division number, and the combination information, and
the primary division points are a plurality of points including both end points of the first side and in positions equally dividing the first side by the primary division number,
the minor line is a line segment that passes through the primary division point and runs from the first side to a second side along a third side,
the secondary division points are a plurality of points including both end points of the minor line and equally dividing the minor line by the secondary division number, and
the minor line pair is a combination of two arbitrary adjacent minor lines among the minor lines, and
the triangle division unit sets the primary division number by the primary division number setting unit and the secondary division number by the secondary division number setting unit for each basic triangle defined by the coordinates of the vertices included in the new vertex coordinate group generated by the addition unit and calculates, by the execution unit, the coordinates of the vertices of the plurality of subdivided triangles that divide the area of the basic triangle into parts smaller than the basic triangle.

5. The triangle generation apparatus according to claim 4, wherein:
in the basic triangle, the first side is an opposing side of an interior angle having a largest angle, the second side is an opposing side of an interior angle having a second largest angle to the largest angle, and the third side is an opposing side of an interior angle having a smallest angle.

6. The triangle generation apparatus according to claim 4, wherein:
the combination information alternately specifies a secondary division point on a minor line set for each primary division point and a secondary division point on an adjacent minor line, for each minor line pair set for each primary division point when specifying the secondary division points belonging to a single subdivided triangle.

7. The triangle generation apparatus according to claim 4, further comprising:
a primary division point identification setting unit that is configured to set a primary division point identification number identifying each primary division point for each primary division point; and
a secondary division point identification setting unit that is configured to set a secondary division point identification number identifying each secondary division point for each secondary division point, wherein
each secondary division point is identified by the primary division point identification number and the secondary division point identification number, and
the combination information specifies the combination method of the secondary division points belonging to the subdivided triangles based on the primary division point identification number and the secondary division point identification number.

8. The triangle generation apparatus according to claim 4, wherein:
the execution unit calculates the coordinates of the vertices of the subdivided triangles in parallel for each primary division point.

9. The triangle generation apparatus according to claim 2, wherein:
the pre-shaping execution unit divides the basic triangle into two by a bisector that bisects an interior angle having a maximum value in the basic triangle when the target determining unit determines that the basic triangle is not the target triangle.

10. The triangle generation apparatus according to claim 5, wherein:
the combination information alternately specifies a secondary division point on a minor line set for each primary division point and a secondary division point on an adjacent minor line, for each minor line pair set for each primary division point when specifying the secondary division points belonging to a single subdivided triangle.

11. The triangle generation apparatus according to claim 5, further comprising:
a primary division point identification setting unit that is configured to set a primary division point identification number identifying each primary division point for each primary division point; and
a secondary division point identification setting unit that is configured to set a secondary division point identification number identifying each secondary division point for each secondary division point, wherein
each secondary division point is identified by the primary division point identification number and the secondary division point identification number, and
the combination information specifies the combination method of the secondary division points belonging to the subdivided triangles based on the primary division point identification number and the secondary division point identification number.

12. A triangle generation method that is configured to acquire a vertex coordinate group including coordinates of each vertex of one or a plurality of basic triangles and divide each basic triangle defined by the coordinates of the vertices included in the vertex coordinate group into a plurality of subdivided triangles, the triangle generation method comprising:
determining whether each basic triangle defined by the vertex coordinate group is a target triangle that has a shape having a relatively high degree of similarity to an equilateral triangle;
dividing the basic triangle determined to not be the target triangle into a plurality of triangles to have the shape having a relatively high degree of similarity to an equilateral triangle;
generating the new vertex coordinate group including the vertex coordinates of the triangles after division; and
for each basic triangle defined by the coordinates of the vertices included in the new vertex coordinate group, calculating the coordinates of the vertices of a plurality of subdivided triangles dividing an area of the basic triangle into parts smaller than the basic triangle.

13. A non-transitory computer-readable storage medium storing a triangle generation program that causes a computer to function as a triangle generation apparatus, the triangle generation program comprising:
an acquiring step that is configured to acquire a vertex coordinate group including coordinates of each vertex of one or a plurality of basic triangles; and
a triangle dividing step that is configured to divide each basic triangle defined by the coordinates of the vertices included in the vertex coordinate group into a plurality of subdivided triangles, wherein
the triangle dividing step includes
a target determining step that is configured to determine whether each basic triangle defined by the vertex coordinate group is a target triangle that has a shape having a relatively high degree of similarity to an equilateral triangle,
a pre-shaping executing step that is configured to divide the basic triangle determined to not be the target triangle into a plurality of triangles to have the shape having a relatively high degree of similarity to an equilateral triangle, and
an adding step that is configured to generate the new vertex coordinate group including the vertex coordinates of the triangles after division, and
for each basic triangle defined by the coordinates of the vertices included in the new vertex coordinate group generated at the adding step, the coordinates of the vertices of a plurality of subdivided triangles dividing an area of the basic triangle into parts smaller than the basic triangle are calculated.
